(19) United States
(12) Patent Application Publication
(10) Pub. No.: US 2023/0384273 A1
(43) Pub. Date: Nov. 30, 2023

(54) LIQUID CHROMATOGRAPHIC DATA PROCESSING APPARATUS

(71) Applicant: HITACHI HIGH-TECH SCIENCE CORPORATION, Tokyo (JP)

(72) Inventors: Masahito ITO, Tokyo (JP); Katsutoshi Shimizu, Tokyo (JP)

(21) Appl. No.: 18/202,626

(22) Filed: May 26, 2023

(30) Foreign Application Priority Data
May 31, 2022 (JP) 2022-89059
Apr. 18, 2023 (JP) 2023-68008

(51) Int. Cl. G01N 30/86

(52) U.S. Cl. CPC G01N 30/8651; G01N 30/8675; G01N 2030/027

(57) ABSTRACT

Disclosed is a liquid chromatographic data processing apparatus capable of easily setting appropriate analytical conditions while taking sensitivity performance into account. The liquid chromatographic data processing apparatus includes a data processing unit that generates display data for performing a display in accordance with correspondence relationships of diameters of particles of a column filler that is data concerning an analytical condition of a chromatography apparatus and analytical characteristics that is data concerning separation performance, and a sensitivity performance index.

### CROSS REFERENCE TO RELATED APPLICATION(S)

This application claims the benefit of Japanese Patent Application No. 2022-89059, filed May 31, 2022 and Japanese Patent Application No.2023-68008, filed Apr. 18, 2023, which are hereby incorporated by references in its entirety into this application.

### BACKGROUND OF THE INVENTION

### 1. Technical Field

The present invention relates to a chromatographic data processing apparatus and, more particularly, to a quantitative visualization analysis apparatus for searching for separation conditions for liquid chromatography.

### 2. Description of the Related Art

Methods for visualizing a relationship between analysis time and separation performance of a high performance liquid chromatograph (HPLC) were disclosed in Patent Literature 1, 2, and 3 in order. In Patent Literature 1, a kinetic performance limit (KPL) method is disclosed in which analysis time is set to hold-up time t₀(s) and separation performance is represented by a theoretical stage number N. A pressure loss ΔP (MPa) was found to be a third important variable axis, and the result was visualized as a three-dimensional graph. In addition, a variable that was referred to as the flow constant C_{f} in Patent Literature 1 and which is the same as the velocity-length product Π (m²/s) disclosed in Patent Literature 2 was introduced for the first time (Equation 1)

Π≡u₀L=u₀²t₀ [Equation 1]

Patent Literature 2 solved the problem that both the linear velocity u₀ (mm/s) and the column length L (mm) interlocked to each other in the background of the three-dimensional graph N(ΔP, t₀) or N(φ, t0) were invisible. In other words, it could be graphically shown that the base plane can be converted from (Π, t₀) to (u₀, L) and converted reversely. In the sense of a coordinate system that logarithmically rotates this correspondence, the conversion was called logarithmically rotating coordinate system (LRC) transformation, and it was conceived from the fact that Π was defined in advance.

Furthermore, Patent Literature 2 also discloses a contour map of N(Π, t₀) with antilogarithmic axes instead of logarithmic axis. In the contour map, the kinetic performance limit (KPL) surface presents a landscape, but the coefficients based on the slope of the landscape are defined as two types: coefficients of pressure-application such as μN/P and μt/P and a coefficient of time-extension (CTE) such as μN/t. Taking the slope of an Opt. method operating at the optimum linear velocity uₒₚₜ (mm/s) as a reference of 1, each coefficient indicates the effectiveness of an operation variable that is activated. Here, it is a remarkable characteristic that the height equivalent to a theoretical plate H (μm) is a function H(u₀), which is a function of u₀, and the minimum value Hₘᵢₙis obtained when u₀ is uₒₚₜ.

In Patent Literature 3, six variables Π, t₀, u₀, L, N, and n can be displayed at the same time by indicating all three axes of a three-dimensional graph as logarithmic axes. The number of theoretical plates per unit length n(m−1) is the inverse of H and is defined as a proportional constant n as shown in Equation 2.

$$N ≡ nL = \frac{L}{H ( {u}_{0} )} \qquad [ Equation 2 ]$$

In addition, the conditions in which each of the functions N(Π) and N (t₀) monotonically increases are disclosed, and the idea that the upper limit values Nₛᵤₚ(Π) and Nₛᵤₚ(t₀) exist is visualized. In the Opt. method, when the linear velocity uₒₚₜ is maintained and L is extended, the upper limit pressure ΔPₘₐₓ, i.e., Πₘₐₓ is reached. In the contour map of N(Π, t₀), the area surrounded by a straight line where uₒₚₜ is constant and the Πₘₐₓ straight line is called the delta region, and the intersection is called the vertex. It is also disclosed that when the number of theoretical plates of the vertex is expressed as Nver(Πₘₐₓ), Nᵥₑᵣ(Πₘₐₓ) cannot exceed 50% of Nₛᵤₚ(Πₘₐₓ).

Next, in Patent Literature 3, the van Deemter formula involving a diameter of to particles d_{P} μm is expressed as Equation 3.

$$H ( {u}_{0} ) = {ad}_{P} + b \frac{1}{{u}_{0}} + {cd}_{P}^{2} {u}_{0} \qquad [ Equation 3 ]$$

where a, b, and c are coefficients.

To take into account the effect on pressure loss, the characteristics of the three-variable function N(ΔP, t₀, d_{P}) were examined with the partial differential coefficient of d_{P} that fixes ΔP and t₀. As a result, it was found that when uₒₚₜ is maintained, the effect of increasing N by reducing d_{P} and the effect of increasing ΔP were just offset. Therefore, when u₀ is greater than uₒₚₜ, the desired H and N cannot be obtained by reducing d_{P}, and the negative effect of the increased ΔP will prevail. Conversely, when u₀ is less than uₒₚₜ, both ΔP and to cannot be maintained even though ΔP and to are fixed partial differential coefficients. When L is extended in the background to maintain ΔP, there is no solution for maintaining to. The same is true when trying to maintain to. Column permeability K_{V} m², dynamic viscosity η Pa·s, and flow resistance φP were introduced into the discussion of pressure loss ΔP (Equation 4).

$$Δ P = \frac{η {u}_{0} L}{{K}_{V}} = \frac{{ϕ}_{P} η {u}_{0} L}{{d}_{P}^{2}} \qquad [ Equation 4 ]$$

In addition, when ΔP is set as an operational variable within the limited scope of the Opt. method, i.e., uₒₚₜ, since dP, N, and to are uniquely determined, a two-dimensional graph related to the definition of ultra-high performance LC (UPCLC) can be obtained. It is visualized with the vertical axis being the impedance time t_{E}(s) that divides t₀ by the square of N, and the horizontal axis being the pressure loss ΔP (MPa). As can be seen from the graph, it is certainly easier to enter the UHPLC world when the pressure is higher, but since ΔP cannot directly show separation performance and is also affected by η and d_{P}, it is not appropriate to adopt ΔP as an identification index for UHPLC. Patent Literature 3 concludes that the UHPLC system and the HPLC system can be distinguished by t_{E} which is an essential identification index based on high speed and high separation performance.

In the present invention, for convenience, the retention factor k of each component is fixed to proceed the discussion. Therefore, the stationary phase (chemical properties of a column filler), mobile phase (eluent composition), solutes (analytes), and column temperature are fixed, and basically isocratic elution is assumed. All results are based on the same separation conditions (stationary phase: C18 silica fully porous filler, mobile phase: 60% acetonitrile aqueous solution, column temperature: 40° C., and sample solute: butyl benzoate).

The retention time t_{R}(s) is obtained by multiplying t₀ by (k+1) (Equation 5).

t_{R}=t₀(k+1) [Equation 5]

### Literature of Related Art

### Patent Literature

[Patent Literature 1] WO2014/030537 [Patent Literature 2] Japanese Patent Application Publication No. 2019-90813 [Patent Literature 3] Japanese Patent Application Publication No. 2022-053475

### SUMMARY OF THE INVENTION

Although high-speed performance and high separation performance have been the subject of discussion so far, the subject of the present invention is a method capable of obtaining good sensitivity performance for HPLC. That is, the present invention aims to facilitate the setting of appropriate analytical conditions while taking into account sensitivity performance.

To achieve the above objective, the present invention relates to a liquid chromatographic data processing apparatus including: a data processing unit that generates analytical condition data and display data of a chromatographic apparatus for perfoiming a display in accordance with a correspondence relationships of analytical property data, in which the analytical condition data is of diameters of particles of a column filler, and the analytical property data are of a separation performance index and a sensitivity performance index.

With the use of the apparatus, it is possible to easily grasp the diameters of particles of the column filler and the correspondence between the separation performance index the and sensitivity performance index, thereby making it possible to easily set appropriate analysis conditions while taking sensitivity performance into account.

That is, according to the present invention, it is possible to easily set appropriate analytical conditions while taking sensitivity performance into account.

In other words, by facilitating recognition of the relationship between each type of data such as the analysis conditions of the chromatographic apparatus, high sensitivity can be achieved while securing a given separation performance, for example, the diameters of particles may be varied, or the column length may be varied while the diameter of particles is fixed. The relationship among each variable is visualized so that analytical conditions desired by a user can be easily found, thereby helping a user to perform condition searching.

It is also possible to provide a liquid chromatographic data processing apparatus that can automatically optimize conditions.

### BRIEF DESCRIPTION OF THE DRAWINGS

FIG. 1 is a three-dimensional graph of Σ(u₀, L).

FIG. 2 a three-dimensional graph of Σₒₚₜ(N, d_{P})

FIG. 3 is a three-dimensional graph of Lₒₚₜ(N, d_{P})

FIG. 4 is a three-dimensional graph of ΔPₒₚₜ(N, d_{P}).

FIG. 5 a three-dimensional graph of tₒₚₜ(N, d_{P}).

FIG. 6 is a two-dimensional graph illustrating an add-on speed-up method.

FIG. 7 is a three-dimensional graph of Nₜ(t₀, d_{P}).

FIG. 8 is a three-dimensional graph of Nₜ(ΔP, d_{P}).

FIG. 9 is a full-logarithmic coordinate system with a z-axis of N and a base plane of (u₀, L).

FIG. 10 is a full-logarithmic coordinate system with a base plane of (φ, t₀) and a z-axis of N.

FIG. 11 is a full-logarithmic uLN-type three-dimensional graph.

FIG. 12 is a full-logarithmic uLN-type contour map and a trajectory like traversing a slope.

FIG. 13 is a flat plate model of a full-logarithmic coordinate system (u₀, L, N)

FIG. 14 is a coordinate system of a full-logarithmic ΠtΛ-type three-dimensional graph.

FIG. 15 is a flat plate model of a full-logarithmic coordinate system (Π, t₀, Λ)

FIG. 16 is a log Λ-log Π cross-sectional view at log t₀=0.

FIG. 17 is a difference between a uₒₚₜ method and a u_{sub} method.

FIG. 18 is a full-logarithmic udn-type three-dimensional graph.

FIG. 19 is an LRC scope function.

FIG. 20 is a bird's-eye view of a d-u₀ plane.

FIG. 21 is a transparent PPP contour map.

FIG. 22 is a Λ-u0 graph.

FIG. 23 is a cross-sectional view of a flat plate model Λ.

FIG. 24 is a schematic view illustrating a liquid chromatographic data processing apparatus.

### DESCRIPTION OF THE PREFERRED EMBODIMENTS

First, an overview of the premise will be given.

First of all, it is necessary to describe in advance what sensitivity performance is.

The term “good sensitivity” refers to a characteristic in which a detection limit or a quantitative limit is low, and in the present invention, a detection limit with a smaller-the-better characteristic is adopted as an indicator of sensitivity performance. For the sake of simplicity, in the present invention, it is assumed that an absorbance detector is used, and the detection limit of HPLC is generally expressed as the concentration of an injected sample. A method that can measure a lower concentration of a sample is regarded as an analytical method with better sensitivity performance.

In the HPLC method, an SN ratio is used to calculate the detection limit. For example, it is assumed that SN ratio 200 is obtained by injecting 1 μL, of an analyte at a concentration of 100 nmol/μL and dividing a detection signal SSN corresponding to the peak height on the chromatogram by baseline noise NSN. When the detection limit is defined with SN ratio=2,1.00 nmol/μL, which is 1/100 times the original sample concentration, is calculated as the detection limit. In addition, when a margin is given and SN ratio=3 is adopted to define the detection limit, the detection limit deteriorates slightly to 1.50 nmol/μL, which is 3/200 times. In any case, the higher the peak height, the larger the detection signal SSN, and thus the larger the SN ratio. Here, the noise NSN is considered to be not dependent on the sample but is assumed to be fixed.

Therefore, in order to lower the detection limit, it is preferable that the concentration of the analyte in the flow cell of the detector is higher. This means that, when a certain amount of analyte is injected, it is preferable that the sample is passed through the column in a state in which the concentration distribution of the analyte in the sample volume is pulsed so as not to broaden the peak as much as possible.

Here, it is modeled that each peak on the chromatogram shows the shape of a normal distribution function. Let the standard deviation of this normal distribution function be σV (μL). σV is the peak volume characterizing the spread of the peak of the analyte in the mobile phase and is proportional to the peak width. In the case of isocratic elution, the number of theoretical plates N is expressed as Equation 6.

$$N = \frac{{V}_{R}^{2}}{{σ}_{V}^{2}} \qquad [ Equation 6 ]$$

Here, VR (μL) is the retention volume. Since σV² is a statistical variance and represents the spatial spread of the peak, σV² is called the peak volume variance. A state in which the concentration of an analyte in the flow cell is high, means that when a certain amount of substance is injected, σV is small. Therefore, the smaller the σV, the larger the SSN corresponding to the peak height, and the lower the detection limit of the SN ratio method.

Equation 7 can be derived from the peak volume variance σV².

$${σ}_{V}^{2} = \frac{{V}_{R}^{2}}{N} = \frac{{t}_{R}^{2} {F}^{2}}{N} = \frac{{\{ {t}_{0} ( k + 1 \}}^{2} {( ε {Su}_{0} )}^{2}}{N} = {\{ ε ( k + 1 ) \}}^{2} {S}^{2} \frac{{\{ {u}_{0} {t}_{0} \}}^{2}}{N} = {{ε}^{2} ( k + 1 )}^{2} {S}^{2} \frac{{L}^{2}}{N} \qquad [ Equation 7 ]$$

Here, F (m³/s) is flow rate, ε is column porosity, S (m²) is column cross-sectional area, and Equation 7 is obtained because the flow rate F (m³/s) has the relationships of Equations 8 to 10.

V_{R}=t_{R}F [Equation 8]

F=εSu₀ [Equation 9]

L=u₀t₀ [Equation 10]

Referring to the configuration of σV² of Equation 7, excluding those that can be regarded as constants, Σ (m²) is defined to factor out performance-related parameters of chromatography (Equation 11).

$$\sum ≡ HL = {H}^{2} N = \frac{{L}^{2}}{N} \qquad [ Equation 11 ]$$

Σ is called the height-length product because it is expressed as the product of the height equivalent to a theoretical plate H (m) and the column length L. Using Σ, σV² of Equation 7 can be expressed as Equation 12.

σ_{V}²=ε²(k+1)²S²Σ [Equation 12]

Since the peak volume variance σV² is preferably small in terms of lowering the detection limit, the high-length product Σ has the smaller-the-better characteristic. First, what Equation 12 represents will be described. The σV² having the smaller-the-better characteristic is proportional to the column cross-sectional area S. In other words, it is desirable to reduce the inner diameter (diameter) of the column from 4.6 mm to 2 mm, and even to 1 mm. Reducing S significantly increases the concentration in the flow cell, thereby contributing to lowering the detection limit. Semi-micron LC exhibits a more advantageous effect on the detection limit than the so-called conventional LC.

In Equation 12, the porosity c and the retention coefficient-related (k+1) factor are multiplied, but these can be considered as constants. When the filler particles in the column are almost spherical, the porosity c is usually about 0.5, and the mobile phase fills the voids. When the mobile phase, the stationary phase, and the analyte are common, the retention coefficient k is constant. Even when the diameter of particles d_{P} (μm) of the filler changes, it is considered that and k are constant.

Reducing the peak volume variance σV² corresponds to reducing S in the radial direction of the column and to reducing Σ in the axial direction of the column. As the name implies, the height-length product Σ is the product of the height H and the length, so it is wise. However, a really brilliant idea for the computation is that Σ is defined as a variable obtained by multiplying the height equivalent to a theoretical plate H, which is a performance index in the axial direction, by the column length L (Equation 11).

The reduction of S means the reduction of the inner diameter of the column. Although not covered in the middle of discussion, the inner diameter may be independently changed before and after a certain discussion. Therefore, theoretically, S may be taken as a constant. In practice, when the inner diameter of the column is less than 1 mm, it is necessary to separately discuss the inner diameter of the column because the influence of the expansion outside the column and the inner wall of the column is not negligible. The present invention deals with sensitivity performance while focusing only on the smaller-the-better characteristic.

### Aspect of Height-Length Product Σ

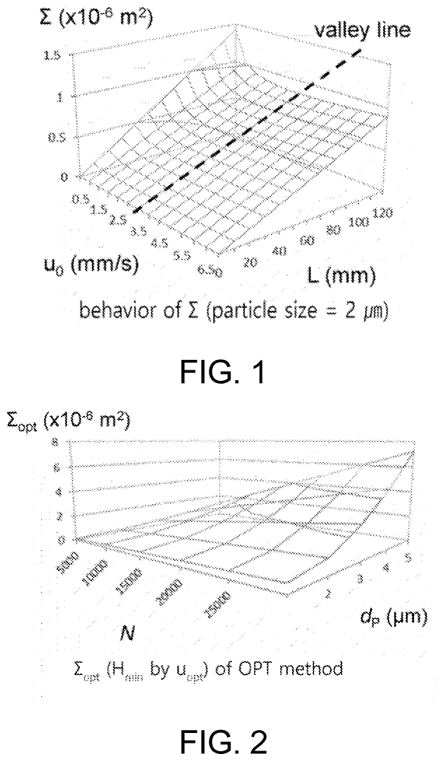

First, for the sake of simplicity, d_{P} is fixed to 2 μm and operation input variables u₀ and L are moved to recognize what kind of characteristic the variable Σ indicates. FIG. 1 illustrates a three-dimensional graph Σ(u₀, L) with a base plane of (u₀, L) and a z-axis of Σ.

Since Σ is the product of H and L, as illustrated in FIG. 1, Σ monotonically increases along a y-axis of L. On the other hand, for u₀ on the x-axis, uₒₚₜ forms a valley line because H has a minimum value Hₘᵢₙ at uₒₚₜ. When the analysis time represented by t₀ is not considered, it can be seen that for the linear velocity, by fixing the linear velocity to uₒₚₜ, the minimum value of each Σ can be obtained for each L.

The reasons for adopting the Opt. method will be described below. As described above, in terms of minimizing the detection limit, σV² has the smaller-the-better characteristic like Σ has the smaller-the-better characteristic. As expressed by Equation 11, since N is multiplied by the square of H, when the separation performance N is requested as an input as described later, the linear velocity is set to the optimum linear velocity uₒₚₜ to minimize the value of Σ, and desirably the minimum height equivalent to a theoretical plate Hₘᵢₙ is obtained. Alternatively, in other words, in the case of uₒₚₜ, L becomes the minimum to obtain N as the input. When the linear velocity is increased to excess the optimum linear velocity uₒₚₜ, since H increases, L must be extended to obtain a constant N. Even in the case where the linear velocity is below uₒₚₜ, L must be extended. Therefore, in the case of minimizing the detection limit, Hₘᵢₙ needs to be obtained by setting the linear velocity to uₒₚₜ. This is the reason for specifying uₒₚₜ, i.e., adopting the Opt. method.

### Visualization for Analytical Condition Search

Next, considering the characteristics of Σ in the base plane (u₀, L) (see FIG. 1), it is possible to optimize the sensitivity performance Σ while securing a predetermined separation performance N using the diameter of particles d_{P} of the column filler as an operational parameter. In other words, while achieving the requested N, the d_{P} is changed as an input parameter, and the response performance of Σ is displayed (see FIG. 2).

An exemplary three-dimensional graph in the present invention:
x-axis . . . separation performance index: number of theoretical plates N (larger-the-better characteristic)
y-axis . . . diameter of particles d_{P} of a column filler
z-axis . . . sensitivity performance index: height-length product Σ (smaller-the-better characteristic)

When x and y are inputted, the column length L is determined unequivocally in the background. Since the Opt. method is adopted, when d_{P} is specified first, the linear velocity is determined unequivocally to be the uₒₚₜ corresponding to the d_{P}, and Hₘᵢₙis determined in conjunction. Next, since the input N is specified, L is essentially determined on the basis of the Hₘᵢₙ.

As can be seen from FIG. 2, when the sensitivity performance Σ is minimized, L that is variable in the background can be gradually shortened. However, as a disadvantage, the separation performance N also decreases in proportion to L. Thus, Σ and N are in a proportional trade-off relationship. Accordingly, a three-dimensional graph as illustrated in FIG. 2 is useful for simultaneously viewing both performance indices in search of optimal conditions according to d_{P}. For example, an optimal condition search method that minimizes Σ by varying d_{P} can be employed by requesting N as an input in advance.

A liquid chromatographic data processing apparatus that displays a three-dimensional graph in which the z-axis represents Σₒₚₜ as in FIG. 2 is useful. However, when using the relationships among the variables, it is possible to construct a liquid chromatographic data processing apparatus that displays an optimum diameter of particles d_{P} at which the sensitivity performance index Σₒₚₜ as an evaluation index becomes optimal (for given data) while receiving the separation performance index N requested by the user. Display data displayed in the form of a table may also be generated. The same is applied to each of the graphs described below.

Here, for the diameter of particles d_{P}, the lower limit is the smallest available diameter of particles d_{Pmin}. Although Σₒₚₜ decreases monotonically with respect to d_{P}, in some cases it may become a boundary condition in which the upper limit of pressure loss ΔPₘₐₓ is reached first. Accordingly, the diameters of particles d_{P} at which the sensitivity performance index Σₒₚₜ is the best is found to be the smallest of the available diameters of particles d_{P} where the lower limit diameter of particles d_{Pmin} is present when the pressure loss is below the upper limit ΔPₘₐₓ. Note that the pressure loss may also be visualized so that the pressure loss can be easily monitored during condition searching.

The degree of influence of d_{P}, which is an operational input variable, can also be read from FIG. 2. First, when d_{P} is gradually decreased, Σₒₚₜ can be simply decreased in proportion to the square of d_{P}. However, the disadvantage is that ΔP is significantly increases.

In addition, apart from the method of improving the sensitivity performance, in the case where N is increased with d_{P} fixed, Σₒₚₜ also deteriorates in proportion to N. On the other hand, the d_{P} is variable, the situation changes. For example, focusing on the contour line where Σₒₚₜ on the z-axis is constant at 2×10⁻⁶ m² in FIG. 2, it is seen that N can be gradually increased by gradually decreasing d_{P}. In other words, it can be seen that there is a method capable of improving the separation performance while maintaining constant sensitivity performance by miniaturizing the d_{P}. However, this method also has a problem of significantly increasing ΔP to reduce d_{P}.

### Relationship Between Σ and Diameter of Particles

A set of physical quantities related to the Opt. method can be obtained from the van Deemter's equation (Equation 3) dealing with the diameter of particles d_{P}. The uₒₚₜ (Equation 13) is derived from the first-order differential coefficient of u₀ using Equation 3, and the minimum value Hₘᵢₙ is expressed by Equation 14. L and Σ3 that can be obtained by the uₒₚₜ method become Lₒₚₜ (Equation 15) and Σ opt (Equation 16), respectively.

$${u}_{opt} = \sqrt{\frac{b}{{cd}_{P}^{2}}} = \frac{1}{{d}_{P}} \sqrt{\frac{b}{c}} \qquad [ Equation 13 ]$$

$${H}_{min} = H ( {u}_{opt} ) = ( a + 2 \sqrt{bc} ) {d}_{P} \qquad [ Equation 14 ]$$

$${L}_{opt} = {NH}_{min} = N ( a + 2 \sqrt{bc} ) {d}_{P} \qquad [ Equation 15 ]$$

$${\sum }_{opt} = {H}_{min} L = {N ( a + 2 \sqrt{bc} )}^{2} {d}_{P}^{2} \qquad [ Equation 16 ]$$

According to Equation 16, since the coefficients a, b, and c of the van Deemter's equation are common to each diameter of particles, Σₒₚₜ is only proportional to the square of N and the diameter of particles d_{P}. In other words, when the diameter of particles becomes ½ times, i.e., changes from 4 μm to 2 μm, Σₒₚₜ improves by ¼ times. For example, when looking at the right-hand side cutout of N=30,000 plates, Σₒₚₜ is increased by a factor of ¼ from 4.63×10⁻⁶ (m 2) to 1.16×10⁻⁶ (m²). In addition, when looking at d_{P}=5 μm on the rear wall side, Σₒₚₜ at N=15,000 plates is 3.61×10⁻⁶ (m²), whereas Σₒₚₜ at N=30,000 plates is 7.23×10 ⁻⁶ (m²), and it can be seen that the detection limit is deteriorated by a factor of two.

ΔP, Π, and t₀ related to the Opt. method will be expressed as ΔPₒₚₜ (Equation 17), Πₒₚₜ (Equation 18), and tₒₚₜ(Equation 19), respectively.

$$Δ {P}_{opt} = \frac{η {u}_{opt} {L}_{opt}}{{K}_{V}} = \frac{{ϕ}_{P}}{{d}_{P}^{2}} η {u}_{opt} {L}_{opt} = \frac{{ϕ}_{P} η}{{d}_{P}^{2}} \times \frac{1}{{d}_{P}} \sqrt{\frac{b}{c}} \times N ( a + 2 \sqrt{bc} ) {d}_{P} = N \frac{a \sqrt{b} + 2 b \sqrt{c}}{\sqrt{c}} \frac{{ϕ}_{P} η}{{d}_{P}^{2}} = N \frac{a \sqrt{bc} + 2 bc}{c} \frac{{ϕ}_{P} η}{{d}_{P}^{2}} \qquad [ Equation 17 ]$$

$${Π}_{opt} = {u}_{opt} {L}_{opt} = \frac{1}{{d}_{P}} \sqrt{\frac{b}{c}} \times N ( a + 2 \sqrt{bc} ) {d}_{P} = N \frac{a \sqrt{b} + 2 b \sqrt{c}}{\sqrt{c}} = N \frac{a \sqrt{bc} + 2 bc}{c} \qquad [ Equation 18 ]$$

$${t}_{opt} = \frac{{L}_{opt}}{{u}_{opt}} = N ( a + 2 \sqrt{bc} ) {d}_{P} \times {d}_{P} \sqrt{\frac{c}{b}} = N \frac{a \sqrt{c} + 2 c \sqrt{b}}{\sqrt{b}} {d}_{P}^{2} = N \frac{a \sqrt{bc} + 2 bc}{b} {d}_{P}^{2} \qquad [ Equation 19 ]$$

Since the tₒₚₜ and Σₒₚₜ obtained by the uₒₚₜ method are each proportional to the square of d_{P}, it is interesting that Σₒₚₜ has a simple proportional relationship with the holdup time tₒₚₜ. In other words, when a predetermined separation performance level can be obtained without taking much time, the sensitivity performance is also improved.

The coefficients and the like used here are as shown in Table 1. These values may be provided in advance, for example, by the apparatus manufacturer or the like, or may be determined by user experiments or the like.

TABLE 1
list of coefficients related to calculation

| a (μm) | b (×10⁻⁹ m²/s) | c (×10⁻¹⁵ s/m²) | ϕ_{P} | η (mPa · s) |
|---|---|---|---|---|
| 18 | 3.97 | 0.11 | 1,500 | 0.54 |

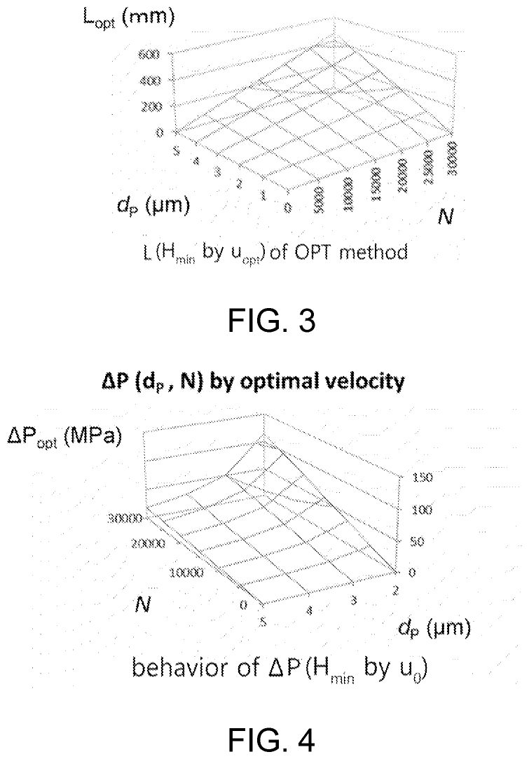

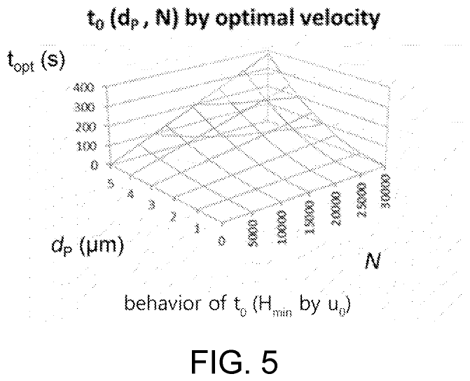

FIGS. 3 to 5 are three-dimensional graphs obtained by plotting Lₒₚₜ, ΔPₒₚₜ, and tₒₚₜ that are linked to Σₒₚₜ(N, d_{P}) in the base plane (N, _{P}p) from which Σₒₚₜ of FIG. 2 can be obtained.

In order to solve the problem, the minimum value of Σₒₚₜ is obtained on the basis of Hₘᵢₙ of the uₒₚₜ method, but the input conditions are found from the base plane using the three-dimensional graph with the z-axis of Σₒₚₜ (FIG. 2). In the actual optimization procedure, whether to set d_{P} to 2 μm or 3 μm is determined in the first stage. As shown in Equation 16, Σₒₚₜ and N are proportional to each other. Therefore, as tunning parameters, Σₒₚₜ and N are balanced. That is, it is determined whether to give priority to the detection limit or separation performance. Operationally, it is deteimined whether Lₒₚₜ is set to 100 mm or to 150 mm. In this case, tₒₚₜ and ΔPₒₚₜ are obtained at the same time from Equation 19 and Equation 17, respectively.

A method of optimizing the column length Lₒₚₜ will be exemplified using FIG. 3, which has a common base plane (N, d_{P}), while looking at the three-dimensional graph with the z-axis Σₒₚₜ of FIG. 2. When d_{P} is first determined to be 3 μm in FIG. 2 and N=30,000 is requested, Σₒₚₜ=2.6×10⁻⁶ (m²) is obtained. Next, it can be read from the three-dimensional graph in which the z-axis is Lₒₚₜ (FIG. 3) that Lₒₚₜ=280 (mm) is required at that time. Since the column is quite long, when the column length is reduced to the half, 140 mm, it can be understood from the proportional relationship that N is 15,000 plates, and Σₒₚₜ also becomes the half, i.e., 1.3×10⁻⁶ (m²). In other words, for a predetermined N and a predetermined d_{P}, it is possible to recognize Σₒₚₜ and Lₒₚₜ from FIGS. 2 and 3, and it is possible to easily grasp Σₒₚₜ and Lₒₚₜ according to changes in N and d_{P}. Therefore, when N and d_{P} are input in FIG. 2, it is possible to check Lₒₚₜ while viewing the output Σₒₚₜ. Therefore, it is possible to easily balance Lₒₚₜ and Lₒₚₜ. Note that the correspondence relationship between each of the column length, the separation performance index, and the sensitivity performance index may be displayed separately as shown in FIGS. 2 and 3. Alternatively, the figures may be combined to simultaneously display the relationships.

On the basis of these relationships, it is possible to construct a liquid chromatographic data processing apparatus that displays the column length Lₒₚₜ at which the sensitivity performance index or the separation performance index as an evaluation index is the best, depending on, for example, the minimum available diameter of particles and the upper limit of the pressure loss, when the separation performance index N or the sensitivity performance index Σₒₚₜ is input.

For example, the problem of minimizing the detection limit under the requested condition of securing N=20,000 plates may be considered. In the case of using a filler with a d_{P} of 2 μm, Σₒₚₜ=0.77×10⁻⁶ (m²) is obtained. In this case, since Lₒₚₜ=124 mm, it is desirable to have a column with a length of 125 mm. However, since an available column has a length of 150 mm, a re-computation is required. For 150 mm, Equation 15 yields Σ=0.93×10⁶ (m²) and N=24,000. For reference, for Lₒₚₜ=100 mm, the results, Σₒₚₜ=0.62×10⁻⁶ (m²) and N=16,000, are obtained. In this case, the requested condition of N=20,000 plates is not satisfied. Eventually, a 150-mm column with a filler diameter of particles of 2 μm will be chosen to minimize the detection limit. At the same time, tₒₚₜ=49 (s) and ΔPₒₚₜ=93 (MPa) are obtained (Table 2).

list of calculation results related to problems

| | | | |
|---|---|---|---|
| Lₒₚₜ (mm) | 100 | 125 | 150 |
| d_{P} (μm) | 2 | 2 | 2 |
| uₒₚₜ (mm/s) | 3.0 | 3.0 | 3.0 |
| Hₘᵢₙ (μm) | 6.2 | 6.2 | 6.2 |
| N | 16,000 | 20,000 | 24,000 |
| Σₒₚₜ (×10⁻⁶ m²) | 0.62 | 0.77 | 0.93 |
| tₒₚₜ (s) | 33 | 41 | 49 |
| ΔPₒₚₜ (MPa) | 62 | 77 | 93 |

### Add-On Speed-Up Method

There is a good practical optimization method for accelerating the optimization after finding high sensitivity performance conditions by using Hₘᵢₙ This is called the add-on speed-up method. Although high sensitivity performance is exemplified here, high separation performance can also be sped up as well. As described above, the minimum solution of Σₒₚₜ is determined on the basis of Hₘᵢₙ, but u₀ exceeding uₒₚₜ can be considered. In this case, the operational conditions d_{P} and L at which Σₒₚₜ have been obtained are fixed.

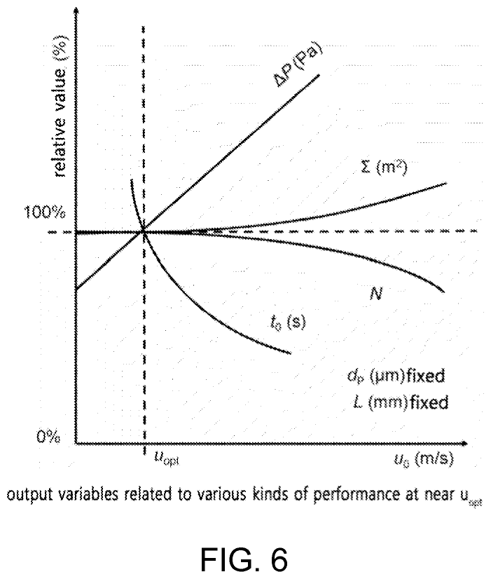

Especially when a filler with diameter of particles of 2 μm or less is used, it is known that H does not deteriorate and almost maintains at Hₘᵢₙ even with increasing u₀. This is because the term of the coefficient c in the van Deemter equation is proportional to the square of d_{P} (Equation 3). The add-on speed-up method is based on the property that H is almost approximate to Hₘᵢₙ even with increasing u₀. First, with Σₒₚₜ as the starting point, when u₀ is increased, t₀ is inversely proportional to u₀ regardless of separation performance and sensitivity performance, and ΔP is proportional to u₀ (FIG. 6).

The add-on speed-up method is like a method of capturing two birds with one stone. That is, by further increasing the flow velocity after optimizing the sensitivity performance through the Opt. method, high-speed performance corresponding to the upper pressure limit is obtained while considering the degree of deterioration in sensitivity. The liquid chromatographic data processing apparatus plots u₀, which is proportional to the flow velocity, on the horizontal axis, and displays sensitivity performance Σ, high-speed performance t₀ related to high speed, and pressure loss ΔP on the vertical axis (FIG. 6). At the same time, if necessary, the separation performance N can also be displayed. Especially when d_{P} is equal to or smaller than 2 μm, since the change in H is small relative to the linear velocity u₀, the deteriorations of Σ and N are accordingly small. However, the response of to can be dramatically faster, so the effect of speeding up is considerable.

As can be seen from FIG. 6, the limiting condition for the add-on speed-up method is the pressure upper limit ΔPₘₐₓ. When the sensitivity performance attributable to the increase in flow velocity u₀ is acceptable, the upper limit condition ΔPₘₐₓ determines the high-speed performance t₀.

### Application of Add-on Speed-up Method to Separation Performance

The speed-up method has been discussed in terms of sensitivity performance above, but the viewpoint will be switched to separation performance. As can be seen from FIG. 6, the required separation performance N is input, and the optimization can be made using the Opt. method. For example, when L is optimized with d_{P} fixed, Lₒₚₜ can be obtained. Prior to obtaining Lₒₚₜ, since uₒₚₜ is uniquely determined by d_{P}, Hₘᵢₙ can be essentially determined.

Here, instead of Σ, the add-on speed-up method can also be applied to N (FIG. 6). u0 is gradually increased, and the speed is increased while checking the degree of decrease in N. That is, t₀ can be decreased. As in the case of Σ, ΔP is the key factor. It is an optimization method in which within an allowable reduction range of N, ΔPₘₐₓ is increased to the upper limit, and the speed-up is stopped at t₀ at that time. The add-on speed-up method is effective when the deterioration of H caused by the c term is overall negligible, i.e., when the d_{P} of the filler is 2 μm or smaller. In fact, since users will use commercially available columns, the users will choose the columns that are discrete in d_{P} and L. Accordingly, it is practical to use a two-dimensional graph in which the horizontal axis represents u₀, and d_{P} and L are fixed, as shown in FIG. 6. In conclusion, even in terms of the separation performance N, it is desirable to first optimize d_{P} and L using the Opt. method, then fix d_{P} and Lₒₚₜ, and then perform tunning by the add-on speed-up method.

### Investigation of Σ-Related Matters Triggered by Fluorescence Detection Method

For an ultraviolet visible absorbance light intensity detector, technical matters related to Σ will be described from the perspective of a fluorescence detector. Here, it is assumed that a sample with an appropriate concentration is injected in a certain amount. Improving the sensitivity performance of a system under such simple conditions in which the sample is not concentrated and the injection volume is not doubled, simply means increasing an SN ratio.

### Probability Density Function with Time Axis

When a substance is injected in an amount of n [mol], a Gaussian-like peak characterized by the standard deviation σₜ[s] appears on the chromatogram on the time axis. This is called the probability density function. Since the area corresponds to n and is constant, when the peak is broad, the peak is linked to σₜ and thus becomes lower. When the noise is assumed to be constant for simplicity, the high sensitivity performance means that the detection signal or peak is high, and the peak width σₜ is narrow. Equation 20 represents a theoretical stage number N obtained from the standard deviation σₜ of time, and is the same as Equation 6.

$$N = \frac{{t}_{R}^{2}}{{σ}_{t}^{2}} \qquad [ Equation 20 ]$$

Here, t_{R} is retention time.

In Equations 6 and 7, it is represented as σᵥ but can be associated with familiar time-axis chromatograms. The volume is the product of the displacement of the solute in the z-axis flow direction and the cross-section of the column perpendicular thereto. This plane is characterized by an effective cross-sectional area of the inner diameter of the column. Accordingly, taking into account only the flow direction, the z-axis displacement of the non-retaining component is equivalent to the time of the chromatogram of the non-retaining component when the linear velocity u₀ is a proportional coefficient. This expression means that the column length L is equivalent to the hold-up time t₀ via u₀. Thus, the equivalence of time and z-axis displacement was ensured.

$${σ}_{V}^{2} = \frac{{V}_{R}^{2}}{N} = \frac{{t}_{R}^{2} {F}^{2}}{N} = {σ}_{t}^{2} {F}^{2} = {( ε S )}^{2} {σ}_{t}^{2} {u}_{0}^{2} = {( ε S )}^{2} {σ}_{z}^{2} \qquad [ Equation 21 ]$$

Here, σ_{z} is the standard deviation in the z-axis flow direction

Referring to Equation 21 derived from Equations 7 and 20, it can be interpreted that the porosity ε is obtained by subtracting an effective column cross-sectional area from the column cross-sectional area S. In Equation 7, the factor (k+1) constituted by the retention coefficient increases the hold-up time t₀ up to the retention time t_{R}, while in Equation 21, σₜ is directly obtained from the retention time t_{R} and the theoretical stage number N. That is, it is found that the spatially expressed σᵥ [m³] can be converted to σₜ [s] via u₀ by dividing by the effective column cross-sectional area εS.

### High-Length Product Σₜ Expressed in Units of Time

In chromatograms, it can be understood that the z-axis displacement in the flow direction is represented by the time axis. On the other hand, the information derived from the column cross-sectional area appears on the vertical axis as described later. The chromatogram of the time axis has the advantage that only the z-axis displacement can be extracted as the horizontal axis coordinate.

Can the argument [m²] be expressed only in units of time? Since Σ is NH², it can be defined that the square of the height H [m] of the plate is stacked by N sheets. The conversion of H into units of time using u₀ produces the plate time t_{P}. Accordingly, the height-length product Σₜ[s²] in units of time is defined by Equation 22.

$${\sum }_{t} ≡ {Nt}_{P}^{2} = {t}_{0} {t}_{P} = \frac{{σ}_{t}^{2}}{{( k + 1 )}^{2}} \qquad [ Equation 22 ]$$

In addition, the squares of Σ and Σₜ used in the coordinate transformations of three-dimensional graphs described later are defined as Ξ [m⁴] and Ξₜ[s⁴], respectively (Equations 23 and 24).

Ξ≡Σ² [Equation 23]

Ξ≡Σₜ² [Equation 24]

### Absorbance Spectrophotometric Detection Method

By using chromatograms on the time axis, the peak area of the probability density function is proportional to the amount of substance. In other words, a chromatogram is considered to be a change in the amount of substance per time along the horizontal axis of time. Under a condition in which the linear velocity u₀ is constant, even though the inner diameter of the column is reduced or increased, the peak shape of the chromatogram is exactly the same, as long as the phenomenon is captured over time. The reason is that the probability density function of the amount of a substance does not change with time on the horizontal axis when the column inner diameter increased or decreased.

However, the absorbance spectrophotometric detection method has the effect of semi-micro LC as mentioned above. This is because S in Equation 7 is reduced, and corresponds to the fact that the sample is not excessively diluted by the mobile phase. This is because the absorbance spectrophotometric detection method detects the concentration of the solute rather than the amount of substance. To avoid diluting the sample, it is advisable to minimize the inner diameter of the column and to reduce the flow rate. When the diffusion caused by the flow cell is taken into consideration, the cell volume should be reduced as the column is made thinner.

On the other hand, according to Lambert-Behr's law, the longer the optical path length of the cell, the more the detection signal can be increased. In the case of the absorbance spectrophotometric detection method, it is desirable to have a small cell volume while maintaining a long optical path length. In reality, this would involve a comprehensive design around the cell so as not to increase the detection noise.

### Fluorescence Detection Method

Fluorescence detectors are ideally regarded as a method of directly detecting the amount of substance, and the action of Σ contributes to high sensitivity. In addition, to increase the detection signal, it is preferable that the volume of the flow cell is simply increased to detect a large amount of substance. The volume increase is excessive, diffusion occurs in the flow cell. For example, it is necessary to design the cell volume to be less than 1/100 of the mobile phase volume that forms the peak.

Since the fluorescence detection method does not detect the concentration, and the amount of substance per unit time does not change as described about the aforementioned time-axis chromatogram, the effect of semi-micro LC conversion cannot be expected. However, it is conceivable to reduce to reduce the mobile phase volume for peak formation, relative to the cell volume at a level that peak broadening does not occur. This is simply a relative inversion of the relationship between the cell volume increase and the mobile phase volume. Even in the case of the fluorescence detection method, when the cell volume is set to a certain condition, since it is desirable that the concentration of the solute in the cell is higher, it is better not to dilute the sample. That is, there is an advantage of semi-micro LC in which the inner diameter of the column is reduced to reduce the flow rate. Since it is not intended to secure the optical path length, the cell shape is arbitrary. Both the absorbance and fluorescence detection methods have the advantage of not diluting although the reasons therefor differ.

### Three-Dimensional Graph with Varying Diameter of Particles

When commercial columns are purchased, d_{P} and L are discrete. However, when designing fillers and columns, d_{P} and L need to be optimized to be continuous, that is, with real variables. In Patent Literature 3, a three-variable function N(ΔP, t₀, d_{P}) is disclosed. When three variables are used as inputs, since another axis is needed for the output N, the graph becomes four-dimensional. However, the four-dimensional graph cannot be illustrated. Three-dimensional graphs such as N(ΔP, t₀) where d_{P} is fixed is disclosed in Patent Literature 1. In the case of three-dimensional graphs, there are two types: N(t₀, d_{P}) with ΔP fixed; and N(ΔP, d_{P}) with t₀ fixed. Showing the three-variable function N(ΔP, t₀, d_{P}) as multiple three-dimensional graphs is useful for giving the user an image. In addition, the three-dimensional graphs may be sent frame by frame so as to be displayed as a moving picture. In any case, with the use of such an image, it is possible to understand the characteristics of the four-dimensional graph.

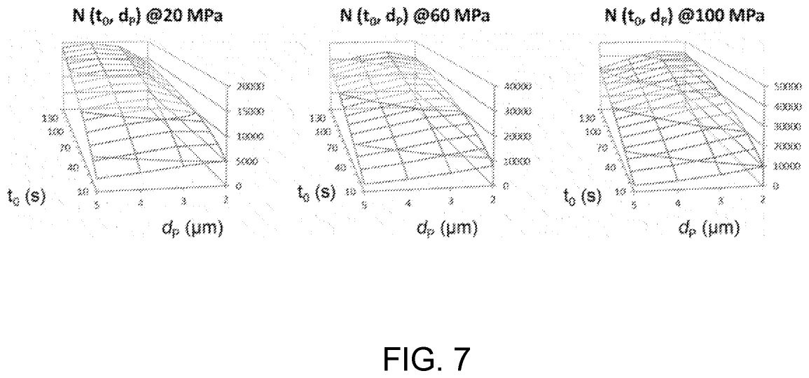

When the linear velocity for a certain d_{P} is uₒₚₜ, it is possible to obtain the maximum N compared to other diameters of particles. However, for example, when looking at the back wall of t₀=150 sec at 60 MPa that is fixed in the graph as illustrated in FIG. 7, N is the maximum at dP=3 μm. Looking along the time axis, it can be seen that the dominance of 2 μm shifts to 3 μm from around 70 sec and thereafter. This is because uₒₚₜ entered the time zone in which 3 μm is dominant. It is shown that when the pressure is fixed, there is a good time zone for each diameter of particles, and as toincreases, d_{P} shifts to a larger side.

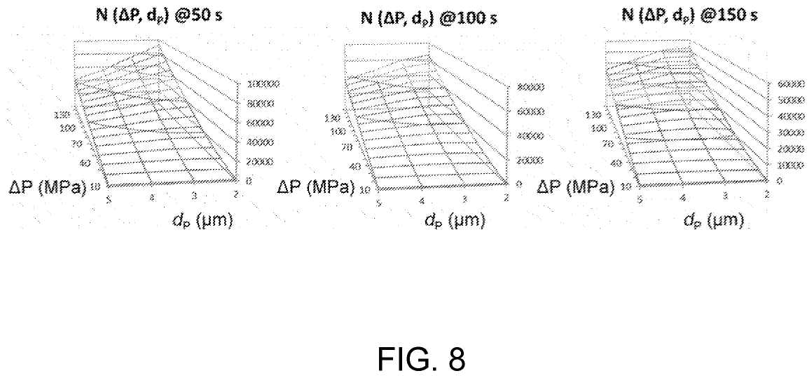

On the other hand, in FIG. 8, time is fixed. For example, the dominance of 3 μm shifts to 2 μm when the application pressure is increased to be larger than 80 MPa on the 100-sec fixed graph. This is because uₒₚₜ entered the dominant pressure band for 2 μm. It is shown that when the time is fixed, there is a good pressure band for each diameter of particles, and as ΔP increases, the dominant pressure band shifts to the side where d_{P} is smaller.

It has been found that even with the graphs with three variables such as N(ΔP, t₀, d_{P}), the situation can be grasped by fixing one variable. The liquid chromatographic data processing apparatus can display the N(t₀, d_{P}) graph as in FIG. 7 and the N(ΔP, d_{P}) graph as in FIG. 8.

### Normalized Pressure

The pressure loss ΔP (MPa) was affected by the viscosity η (Pa·s) of the mobile phase as expressed by Equation 4, and there was a problem that performance indices related to the driving ability of the HPLC system and the pressure of the analysis method cannot be compared and evaluated correctly. To solve this problem, the normalized pressure p_{η}(s−1), which is normalized by viscosity, is defined using Equation 25.

$${p}_{η} ≡ \frac{Δ P}{η} = \frac{{u}_{0} L}{{K}_{V}} = \frac{{ϕ}_{P} {u}_{0} L}{{d}_{P}^{2}} = \frac{{ϕ}_{P} Π}{{d}_{P}^{2}} = \frac{Π}{{K}_{V}} \qquad [ Equation 25 ]$$

The viscosity η of pure water is 1 mPa·s at 20° C. When ΔP is 100 MPa in the case of using 20° C. pure water as a mobile phase, p_{η} becomes 10¹¹s⁻¹. When the mobile phase is a 60% aqueous acetonitrile solution, the viscosity is as low as η=0.54 mPa·s, making it difficult to apply low pressure. Thus, even at the same ΔP of 100 MPa, p_{η} becomes 1.85×10¹¹s⁻¹. It can be seen from Equation 25 that the strength of the driving ability acting on the HPLC, that is, the degree of influence on the velocity-length product Π can be more appropriately quantified by using the normalized pressure rather than simply using the pressure index. By using not only an HPLC system to which 100 MPa can be applied but also an analysis method involving p_{η} of 10¹¹s⁻¹ which as has the larger-the-better characteristic, a purely comparative evaluation of high-speed and high-separation performance can be performed. The significance of defining p_{η} will be described later.

By introducing the concept of p_{η}, it is possible to universally express ΔP which may vary with the viscosity of the mobile phase depending on the analytical method. For example, it is better to understand p_{η}by converting ΔP (MPa) at each viscosity to ΔP (MPa) at η=1 mPa·s. In other words, 100 MPa at 0.54 mPa·s described above is equivalent to 185 MPa as the normalized pressure p_{η}. Rather than a simple expression that the actual ΔP is 100 MPa, the expression that it is an analysis method equivalent to 185 MPa as the normalized pressure p_{η} when taking into account the viscosity better represents a remarkable driving ability. In the case of low viscosity, the driving ability can be shown to be stronger than the actual pressure. Rather than the expression that the maximum pressure of the UHPLC apparatus is 100 MPa, it is better to express that the analysis method is equivalent to 185 MPa as the normalized pressure. It is convenient to use 1 mPa·s as the reference for the viscosity when expressing the equivalent pressure. p_{η} is equivalent to 100 MPa at 10¹¹s⁻¹, and p_{η} s equivalent to 1 MPa at 10⁹s⁻¹.

When p_{η} is viewed at a micro level, the linear velocity u₀ when the mobile phase flows through the gap between the filler particles is influenced by the viscosity η. This can also be seen from the fact that even though u₀ is constant, ΔP increases proportionally to η (Equation 4). In other words, ΔP is represented in units of Pa because the unit of η contains Pa. The unit Pa of pressure or stress is a combined unit indicated by kg·m⁻¹·s². It is thought that the unit of mass, kg, is found in the separation theory of chromatography because of the existence of a viscosity. p_{η} is defined as a physical quantity that is not affected by viscosity. The unit thereof is s⁻¹. Therefore, when the normalized pressure p_{η} is used instead of the pressure, the separation theory of chromatography can be expressed only in units of length and time, that is, m and s.

Newtonian fluids have similar physical quantities. For example, when a 1-mm gap between two separate plates is filled with a liquid, one of the two plates is fixed, and the other plate is moved in the longitudinal direction, a velocity gradient occurs in the normal direction The shear rate (s⁻¹) is a physical quantity obtained by dividing the linear velocity (m/s) by the interval (m). The proportional coefficient connecting the shear rate (s⁻¹) and the shear stress (Pa) is the viscosity η(Pa·s). When the shear stress is considered to be due to the presence of viscosity, it is not necessary to incorporate viscosity into the theory, and it is sufficient to deal with only the shear rate. Referring to the units, it is possible to recognize that p_{η} corresponds to the shear rate.

Shear-driven chromatography (SDC) utilizes a shear rate between two plates, but does not particularly require viscosity for formulation. In SDC, the average u₀ in the axial direction is ½ times the relative movement speed of the plates. It is thought that it possible to visualize the high-speed separation performance of HPLC and SDC in a unified manner without using viscosity. The shear rate of the SDC describes the gradient along which the linear velocity is distributed from the movement velocity to zero toward a second flat plate that is stationary from a first flat plate that is movable. The shear rate (s⁻¹) represents the change in linear velocity (m/s) per interval d (m) between two plates. On the other hand, when the normalized pressure p_{η} (s⁻¹) of HPLC is microscopically viewed, it exhibits the behavior of the linear velocity between the filler particles. In other words, it can be considered that it expresses the linear velocity distribution of the mobile phase flowing along the center between the stationary particles. In other words, the linear velocity in the axial direction has a microscopic gradient in the radial direction. The micrometer in this case is the size order of the distance between the particles. In HPLC, u₀ is the average linear velocity, and the viscosity η is the flowability of the mobile phase (Equation 4). Assuming that the normalized pressure p_{η} is caused by the micro-order inter-particle linear velocity distribution η of HPLC, it is considered that the shear rate and the normalized pressure p_{η} are homogeneous indices corresponding to each other. Using p_{η}, which reflects the micro velocity gradient of the axial linear velocity, which appears in the radial direction, it is possible to uniformly visualize the high-speed separation performance of HPLC and SDC without the need for viscosity. In addition, with regard to the unification of HPLC and SDC, it is noted again that the speed-length product Π is useful because it is a variable that does not affect both the viscosity η and the column permeability K_{V}.

### Full-Logarithmic Three-Dimensional Graph Representing Column Permeability

The diameter of particles d_{P} has two working aspects for H (Equation 3) and ΔP (Equation 4). In Patent Literature 3, the N-Π graph was represented under ideal conditions to show the effect on H when the d_{P} becomes ½ times. In addition, to show the effect of d_{P} on ΔP, the impedance time t_{E} was introduced to represent the t_{E}-ΔP graph while limiting to the Opt. method.

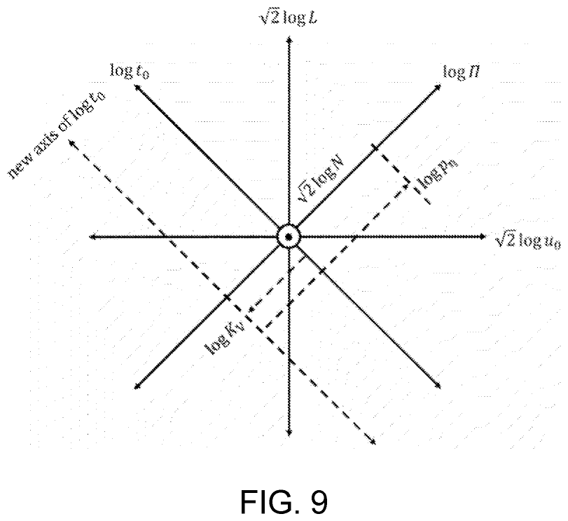

FIGS. 7 and 8 are intended to visualize a four-dimensional graph from this perspective. As can be seen from Equation 25, since Π is the product of p_{η} and K_{V}, when Π is expressed on the logarithmic axis, p_{η} and K_{V} can also be expressed on the numerical line of the Π-axis (FIG. 9).

FIG. 9 is an extension of the full-logarithmic three-dimensional graph of Patent Literature 3. The operational variables u₀ and L are on the base plane, and N is expressed on the z-axis. In the LRC transformation, the base plan is rotated by 45° from the base plane (u₀, L) to the base plane (Π, t₀). In FIG. 9, (u₀, L, N) is multiplied by the scaling factor of √2 to make the base plane (Π, t₀) the main axis. Since both log N and log L are multiplied by √2, a proportionality with a slope of 1 is secured in the graph (Equation 2). In addition, a cliff cross section n(u₀) is formed on the vertical plane including the z-axis on the √2log u₀ axis.

FIG. 9 features that the new log to axis is shifted to the lower left side by log K_{V}. The amount of pressure applied from the new log t₀ axis in the Π-axis direction corresponds to log p_{η} (Equation 25). In this way, the column permeability K_{V} can be visualized. When the diameter of particles d_{P} is reduced, the K_{V} decreases, and the new log t₀ axis is shifted to the lower left side. When the d_{P} is increased, it is shifted in the opposite direction. In the MKS unit system, K_{V} (m²) is in the order of 10⁻¹⁵, and p_{η} (S⁻¹) is in the order of 10¹¹, and thus Π(m²/s) is in the order of 10⁴. FIG. 9 is illustrated such that log Π is expressed in mm·mm/s so as to be positive.

Since the cliff cross section n(u₀) is reflected as the inverse of H(u₀), i.e., a mirror image, the influence of d_{P} can be visualized. After all, using FIG. 9, the two working aspects of d_{P} for H and ΔP can be expressed. That is, they are cliff cross section n(u₀) and the K_{V} shift of the new log t₀ axis.

Even in a monolithic column that cannot be expressed simply by d_{P}, in the case of a K_{V} index, the pressure-related characteristics can be expressed by a graphical representation. In addition, even though the monolithic column cannot be expressed by d_{P}, the monolithic column can be expressed as a cliff cross section in the case of n(u₀).

For reference, the definition of the impedance time t_{E} will be described again (Equation 26). By expressing the K_{V} outside the full-logarithmic three-dimensional graph, and looking at the beginning and end of Equation 26, it can be seen that the normalized pressure p_{η} is expressed on the principal x-axis instead of the speed-length product.

$${t}_{E} ≡ \frac{{t}_{0}}{{N}^{2}} = {\{ \frac{H ( {u}_{0} , {d}_{P} )}{L} \}}^{2} \frac{L}{{u}_{0}} = \frac{{\{ H ( {u}_{0} , {d}_{P} ) \}}^{2}}{Π} = \frac{{\{ H ( {u}_{0} , {d}_{P} ) \}}^{2}}{{K}_{V} {p}_{η}} = \frac{{ϕ}_{P} {\{ H ( {u}_{0} , {d}_{P} ) \}}^{2}}{{d}_{P}^{2} {p}_{η}} = \frac{E ( {u}_{0} )}{{p}_{η}} \qquad [ Equation 26 ]$$

Here, the separation impedance E is a variable obtained by dividing H² by K_{V}. Fundamentally, it is seen that t_{E} is a variable obtained by dividing E by p_{η}. Since H is a function of u₀ and d_{P}, and KV is a function of d_{P}, t_{E} can also be expressed as a three-variable function of u₀ and d_{P}, and p_{η}.

The three-variable function N(u₀, L, dp) maintains three degrees of freedom and can be expressed as N(u₀, p_{η}, d_{P}). The full-logarithmic three-dimensional graph as shown in FIG. 9 is N(p_{η}, t₀) derived from the three-variable function, and without limiting to the Opt. method, the properties of d_{P} independently appeared in the cliff cross section n(u₀) and the K_{V} shift, respectively. The dimensionless index E(u₀) may have been originally conceived to simply connect H(u₀) and K_{V}, which were originally independent, with d_{P}, but as a result, E(u₀) can be extended to non-particle monolithic columns and core-shell columns and well matches with the t_{E} property. A special case where the effect of d_{P} is destructively distributed to H(u₀) and K_{V} so that E(u₀) is kept constant was the condition for the optimum flow rate uₒₚₜ . Aside from uₒₚₜ, since the negative effect on KV is significant, even though the d_{P} is decreased, E(u₀) will be deteriorated rather and be increased.

Patent Literature 3 shows a graph with a vertical axis of t_{E}(s) and a horizontal axis of ΔP, which is related to the definition of UHPLC. In the case of changing the horizontal axis from ΔP(MPa) to p_{η}(s⁻¹), it is not necessary to take into account the influence of η, and UHPLC can be distinguished from HPLC in a more desirable manner. One effect of p_{η} will be described below. The square N² of the number of theoretical plates will be described as Equation 27 below, but when the vertical axis is the inverse of t_{E}(s), that is, N² per unit time, it becomes a graph showing the correlation thereof. Interestingly, both the vertical axis t_{E}⁻¹ and the horizontal axis p_{η} of the graph for distinguishing UHPLC are unified only in terms of time, s⁻¹.

### Genuine Full-Logarithmic Three-Dimensional Graph

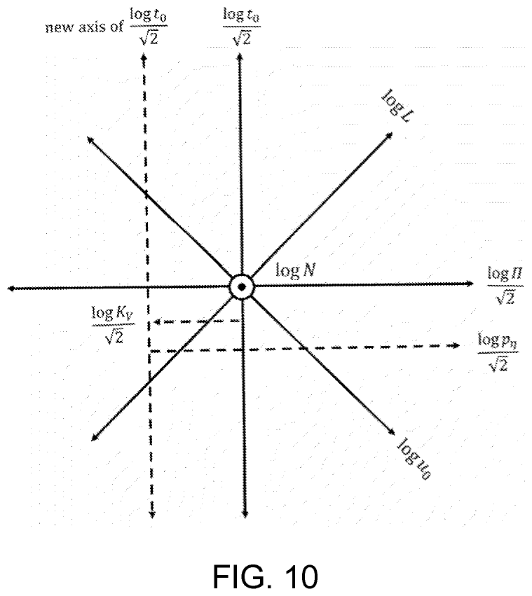

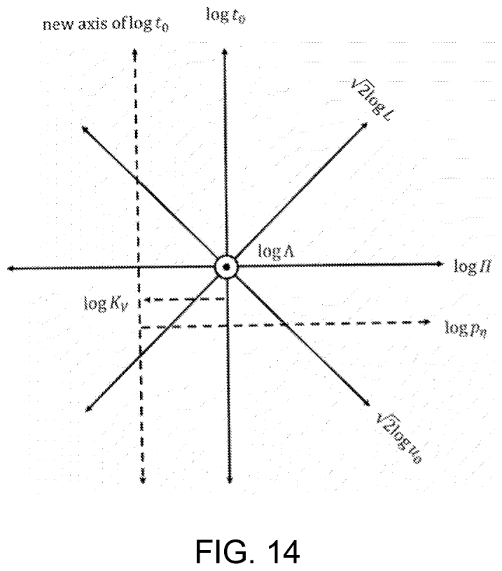

Since the scales of the axes show relative relationships, when the three axes in FIG. 9 are each divided by √2, the results are expressed as in FIG. 10. The scales of the operational variables u₀ and L are changed not to have √2. Since the operational variables are the cause of √2, √2 was added to the results, p_{η} and t₀. Redundantly, which side is √2 to be added to is arbitrary because it is a relative relation. When considering the mechanism, it is better to use the notation shown in FIG. 10 because it is easier to understand the input/output relationship in which the operational variables are input and the result variables are read out using a scale. The reverse notation is shown in FIG. 14, and another effect of FIG. 14, which will be described later, is expected.

In addition, referring to Equation 21, it can be seen that N² is proportional to each of to and p_{η}. This proportional relationship can be described by briefly referring to FIG. 10 and primarily referring to FIG. 14. As a preparation, the coordinate system illustrated in FIG. 10 is expressed by rotating the axes illustrated in FIG. 9 by 45° clockwise.

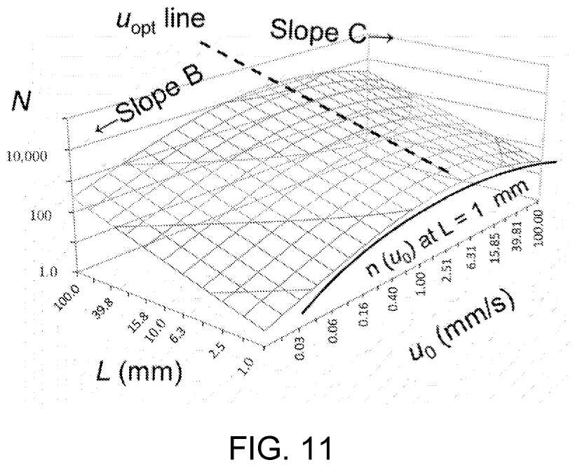

FIG. 11 is a three-dimensional graph using the full-logarithmic coordinate system shown in FIG. 10, showing a landscape in which log N of diameter of particlesof 2 μm is represented by a two-dimensional curved surface. The log u₀ and log L axes are used for the base plane of the input system. The cliff cross section n(u₀) appears on the log u₀ axis. The n(u₀) is a convex curve protruding upward, and the value of the coordinate L, which appears as a cross section, is 1 mm, which is the column length. The landscape appears to be monotonically increasing with respect to L, with the uₒₚₜ line as the ridge. Since N is proportional to L as indicated by Equation 2, the logarithmic notation, log N, increases with a gradient of 1 from the cliff cross section n(u₀) for log L for any u₀.

In FIG. 10, log N presents a landscape in which log N increases with a gradient of 1 with respect to log L. However, in the case of (log t₀)/√2, it is projected such that log L increases by 1 only when log to increases by √2. This scaling factor 1/√2 implies that log to must be increased by √2 rather than 1. In a square having an exact length of 1 in each side, the diagonal length is √2. When log t₀ increases by √2, log L increases by 1. As a result, log N proportional to log L also increases by 1.

### Introduction of Theoretical Plate Square Number Λ

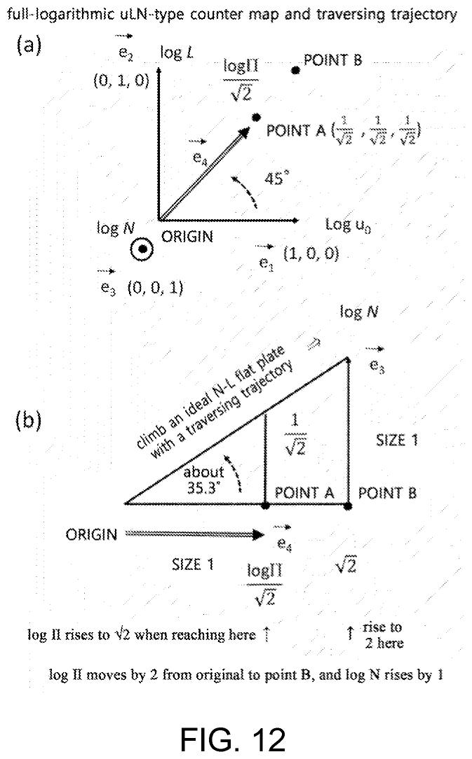

Although described in Patent Literature 3, FIG. 12a is a contour map overlooking a full-logarithmic uLN-type three-dimensional graph. An ideal flat plate with a 45° gradient is set up in which log N increases by 1 when log L increases by 1. Bias FIG. 12b is a cross-sectional view perpendicular to the (log Π)/√2 axis. It is expressed as log N=(½)logΠ+C where when log Π advances by 2, log N increases by 1, and N² is proportional to Π. Similarly, t₀ is proportional to N².

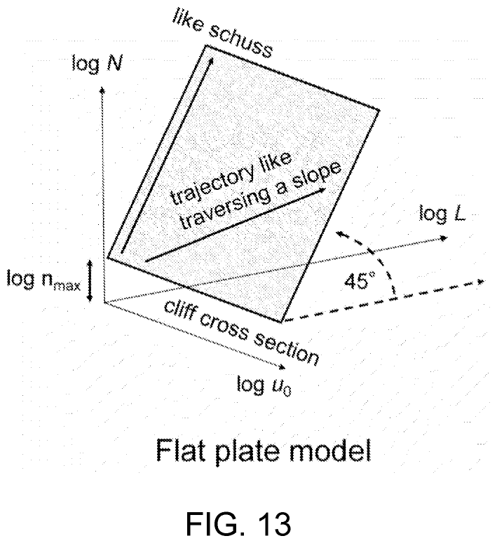

FIG. 13 is a stereoscopic representation of FIG. 12. Although not depicted in the schematic diagram of the three-dimensional graph shown in FIG. 13, when viewing from above to be illustrated as a plan view like FIG. 12a, (log Π)/Π2 axis is located at the position corresponding to a 45° counterclockwise rotation toward the log L axis from the log u₀ axis of the base plane. In the schematic diagram, the flat plate has an inclination of 45°. The gradient of the 45° inclination upon on a schussing trajectory corresponds a gentle inclination angle of about 35.3° on a trajectory like traversing a slope.

The behavior of to is similar to that of Π. When log t₀ is moved right by +2, since the scaling factor 1/√2 is applied to the axis, +√2 goes forward on the graph. In a triangle with an apex angle of about 35.3°, the height log N rises by +1. Since +2 in log t₀ corresponds to +1 in log N, log N=(½) log t₀+C, that is, N² is proportional to t₀. The term “about 35.3° ” is θ obtained from the tan θ with the base of √2 and the height of 1. Although the flat plate of FIG. 13 has an arbitrary constant C in the z-axis direction, the flat plate model of the present invention assumes that there is a bias as large as the maximum value nₘₐₓ of n(u0), which will be described later.

Let N² be the square of the theoretical plate number Λ and let Λ be the z-axis of the logarithmic three-dimensional graph.

Λ≡N² [Equation 27]

A good feature that N is proportional to L is difficult to understand, but a good relationship that Λ is roughly proportional to to can be visualized. Similarly, Π is roughly proportional to Λ like t₀. Although it is expressed as being roughly, but in the case of the flat plate model the term “roughly” will be replaced with the term “strictly” . The scaling factor 1/√2 applied to the scales of the to axis and the Π axis is relative. In addition, the scale, including the log N axis, is multiplied by √2, and thus along the log to axis and the log Π axis, it gently rises in the landscape of √2 log N, with a trajectory like traversing a slope. However, by introducing Λ, only the scale of is the z-axis is further scaled up by √2 times, and thus the notation of 45°-climbing along the log Π-axis (FIG. 14) is adopted. 45°-climbing on the logarithmic axis implies that Λ is proportional to t₀ and Π. Meanwhile, since Λ is proportional to L2, in the logarithmic axis notation flat plate model, the steep slope of about 54.7° of log Λ is made along the √2 log L axis, which corresponds to a schussing trajectory. The term “about 54.7°” is φ obtained from the tan φ with the base of 1 and the height of √2. The introduction of Λ results in a good 45° traversing trajectory along the log Π axis.

Therefore, a flat plate with a steep slope of about 54.7° was adopted along the √2 log L axis, which becomes a schussing trajectory.

### Visualization Approach

In order to visualize the separation performance, a description will start with H(u₀) of the van Deemter plot, which is a source of separation performance. Since H(u₀) is a u₀ -dependent function, the horizontal axis inevitably becomes a graph of u₀. The vertical axis indicating the separation performance is intended to set with N having the larger-the-better characteristic. However, when H(u₀) having the smaller-the-better characteristic is used as it is, there is a concern of interfering with the user intuition. To help that intuition, n(u₀) having the larger-the-better characteristic is introduced (Equation 2). n(u₀) is the inverse of H(u₀) and is a useful variable for visualization as described below. As can be seen from Equation 2, as the input variable N, L as well as u₀ is required. Therefore, the input variable of the three-dimensional graph becomes the base plane (u₀, L). As a result, the z-axis of the three-dimensional graph is represented by the output variable N, and the three-dimensional graph takes the form N(u₀, L). Here, L serves as an extensive variable for N.

Next, there may be a desire to visualize the relationship between high separation performance and high speed. In the KPL method, t₀ is used to express high speed. For the high speed, since t₀ has the smaller-the-better characteristic, so for example, the inverse hold-up frequency v₀ (Hz) of t₀ can be introduced as a variable for a larger-the-better characteristic.

v₀≡t₀⁻¹ [Equation 28]

v₀ refers to the number of hold-up times t₀ that can be counted per second, and the larger the faster. It is also possible to use v₀ having the larger-the-better characteristic as necessary, but in the present invention, t₀ having the smaller-the-better characteristic is used as an index indicating high speed, as an extension of the KPL method. The KPL method expresses the correlation between the high separation performance N and the high speed t₀ as a t₀-N graph, which means that it takes time to obtain high separation performance.

At first glance, it seems that there is no relationship between the aforementioned three-dimensional graph N (u₀, L) and the t₀-N graph of the KPL method. However, it is found that t₀ can be obtained by expressing the base plane (u₀, L) of the three-dimensional graph with a logarithm. Since t₀ is a variable obtained by dividing L by u₀, it is visualized by rotating the axis using the logarithm through the LRC transformation. In other words, the landscape that appears on the three-dimensional graph N(u₀, L) remains as it is, and a new coordinate axis to appears through the LRC transformation. Therefore, t₀ can be measured by only transfoming the coordinate axis. Interestingly, as a by-product, Π orthogonal to the logarithmic axis t₀ was also found. This velocity-length product Π is a variable proportional to the pressure loss ΔP. Therefore, even though the landscape showing high separation performance is common, the logarithmic base plane (U, t₀) to can be obtained by simply rotating the axis from the logarithmic base plane (u0, L), and at the same time, the high speed t₀ and the pressure-related index Π can be visualized.

In addition, the z-axis N of the three-dimensional graph may remain as an antilogarithm, but since N is proportional to L, the gradient of the landscape, which is represented as N of the z-axis in a logarithmic notation, appears as 1 along L. This is also a very good feature.

Incidentally, although the column permeability K_{V} is an important constant that characterizes the filler in addition to H(u₀), it is considered to be a completely independent variable from the separation performance described so far. However, in practice, in the pressure-driven chromatography (PDC), since the upper limit ΔPₘₐₓ of ΔP exists, it seems that there is no choice but to consider K_{V} indirectly. In the case of a shared-driven SDC, it may be sufficient to deal with Π orthogonal to t₀ in logarithmic notation. However, since ΔPₘₐₓ is present in the PDC, it is necessary to analyze the factor in detail along the Π axis in the logarithmic notation.

### Effect of K_{V}

In the case that n(u₀) is constant, i.e., an nₘₐₓ flat plate model, in FIG. 14, the flat plate landscape implies that the value of log Λ of the z-axis increases proportionally along the Π axis. In other words, the slope of the trajectory like traversing a slope is 1. On the other hand, the schussing trajectory is measured along the √2 log L axis, but the slope is √2. When log L advances by +1, it first expands to √2 on the graph. Next, when climbing the flat plate along a schussing trajectory, the value of the z-axis becomes √2 times, meaning an increase of +2. In the end, as shown by “log Λ=2 log L+C”, the relationship that Λ is proportional to the square of L can be drawn.

The effects of K_{V} will be described with reference to FIG. 14, which makes it easier to see the effects of the Π axis. The log K_{V} pulls the origin of the log p_{η} toward the negative side on the log Π axis. The origin of log p_{η}=0 is the point where the value of p_{η} is 1 s⁻¹, and a new log t₀ axis orthogonal to the origin is set. FIG. 14 illustrates a characteristic in which the scaling factor of the Π axis and the t₀ axis is 1. The z axis suitable for that notation is Λ. In other words, FIG. 14 is a ΠtΛ-type three-dimensional graph of a performance result system in a full logarithmic notation.

The K_{V} indicates the column permeability. For example, because a monolithic column has a relatively high liquid permeability, the value of the K_{V} is large, and the origin of the log p_{η} is relatively located on the positive side on the Π axis. Conversely, at a diameter of particles of 2 μm, the value of K_{V} is relatively small, and the origin of log p_{η} is pulled in a relatively negative direction. It is considered that the movement of the origin of log p_{η} is attributed to K_{V}, and the degree of influence of K_{V} can be visualized by the three-dimensional graph.

### Separation Impedance

In fact, in order to represent the image of the separation impedance E, a flat plate model of nₘₐₓ of a full-logarithmic t-type three-dimensional graph was prepared. The term “nₘₐₓ” is the inverse of Hₘᵢₙ expressed in Equation 14 (Equation 29).

$${n}_{max} ≡ {H}_{min}^{- 1} = {\{ H ( {u}_{opt} ) \}}^{- 1} = \frac{1}{( a + 2 \sqrt{bc} ) {d}_{P}} \qquad [ Equation 29 ]$$

In an ideal formula including a diameter of particles, it can be seen that nₘₐₓ is inversely proportional to d_{P}. When the diameter of particles is 2 μm, the nₘₐₓ becomes 2 times larger and better compared to the case of 4 μm. In addition, it can be seen that the height of the cliff cross section at the log L=0 intercept is 2log nₘₐₓ in the flat plate model of the three-dimensional graph with the z axis Λ. Here, a ridge-profiling function f(u₀) will be defined as a preparation (Equation 30).

n(u₀)≡nₘₐₓf(u₀={H(u₀)}⁻¹ [Equation 30]

Since nₘₐₓ has the maximum value, the value range of f(u₀) is 1 to 0, and when u₀ is uₒₚₜ, nₘₐₓ, which shows a ridge, can be obtained. In addition, f(u₀) is the inverse of the normalized function H(u₀)/Hₘₐₓ which is a division of H(u₀) by Hₘᵢₙ. H(u₀)/Hₘᵢₙ, which is the source of the reciprocal, can be called the valley-profiling function, and the value range is 1 to +∞.

Herein above, the cliff cross section of the z-axis log Λ on the √2 log u₀ axis has been described, and it has been understood that the elevation of the cliff cross section, 2 log nₘₐₓ, is ideally dependent on the diameter of particles d_{P} (FIG. 14). In the case of the flat plate model of nₘₐₓ, for example, when the elevation of the cliff cross section is determined by a single parameter, d_{P}, since the gradient of the schussing trajectory is constant as about 54.7°, the full-logarithmic ΠtΛ-type landscape is determined. However, in the case of PDC, even though the landscape is determined, it is not possible to avoid the influence of pressure loss. When looking at the log Π axis, the origin of the normalized pressure log p_{η} coordinates is shifted due to the value of K_{V}. In other words, even at the same normalized pressure, p_{η}, since the log Π coordinate points are affected by the K_{V}, the climbing condition of the flat plate also changes. Referring to Equation 4, K_{V} is proportional to the square of d_{P}. For example, when the diameter of particles changes by ½-fold from 4 μm to 2 μm, the nₘₐₓ is doubled, but the K_{V} becomes ¼ times. The increment of the z-axis Λ is +0.60 computed from logio 4, and the shift of the log KV on the log Π axis is −0.60 computed from −log₁₀ 4. Therefore, in the flat plate model, the rising amount in the z-axis is offset by the displacement of the origin of the log p_{η} coordinates.

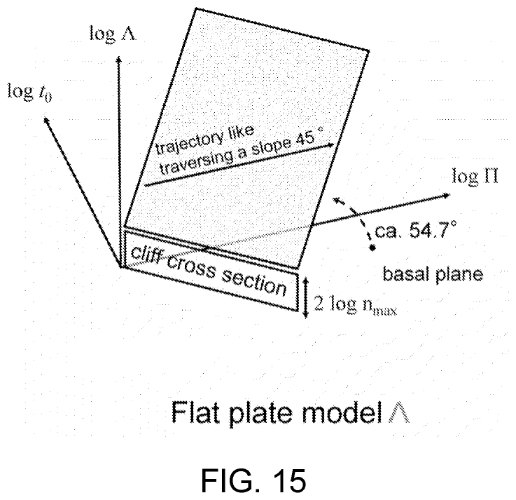

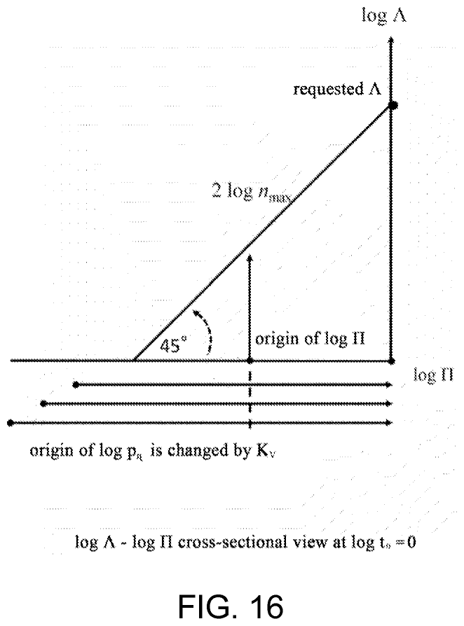

FIG. 15 is a full-logarithm ΠtΛ-type three-dimensional graph in which the z-axis is set to log Λ and the base plane is defined by log Π and log t₀, and is a schematic representation of the flat plate model. FIG. 15 illustrates that the cliff cross section at log L=0 is only uniformly determined by one parameter, nₘₐₓ. A trajectory like traversing a slope means that the gradient is adjusted to 45° as described above, and FIG. 16 illustrates a cross-sectional view of a flat plate model.

First, the height of the z-axis at the origin of log Π=0 is determined to be 2 log nₘₐₓ. The horizontal axis shown in FIG. 16 is the log Π axis at log t₀0. For example, when there is a request for an arbitrary theoretical stage number N, the square number Λ is determined, and the necessary Π is derived. Conversely, it can also be interpreted that inputting Π of the horizontal axis results in outputting Λ of the z-axis. In addition, it is noted that when climbing the flat plate in the positive direction of log t₀ with log Π=0, a trajectory like traversing a slope having a gradient of is formed along the log t₀ axis. The full-logarithmic ΠtΛ-type flat plate model is only determined by nₘₐₓ, but it is a case where the explanation is closed up to the velocity length product Π. The pressure loss must be explained using p_{η} and K_{V}. In other words, in order to estimate p_{η} from Π, K_{V} is required. K_{V} is also required in the logic of outputting Π from the input p_{η}. K_{V} is indispensable for the consideration of pressure loss, and it can be simplified such that the fundamental characteristic parameters of the filler are nₘₐₓ and K_{V}.

In FIG. 16, three types of origin of log p_{η}=0 are shown. Schematically, from the top are the origins of diameters of particles 5 μm, 3 μm, 2 μm, respectively which are shifted from the K_{V} difference. In other words, the larger the diameter of particles, the larger Π can be obtained at the smaller p_{η} because the p_{η} is effectively converted to Π. Conversely, even though a large nₘₐₓ is obtained by using a filler with a small diameter of particles, the K_{V} decreases, and p_{η} shifts in the negative direction. After all, for small-sized fillers, the same p_{η} will not give a valid Π.

This relationship can also be represented by a formula. Equation 31 shows the contribution of the diameter of particles d_{P} to the z-axis direction. Terms including a, b, and c are constants.

log Λ=2 log nₘₐₓ=−2 log d_{P}−2 log(a+2\sqrt{bc}) [Equation 31]

On the other hand, the contribution to the log Π axis direction is shown by Equation 32. Similarly, the term including (φP is a constant.

$$log {K}_{V} = log \frac{{d}_{P}^{2}}{{ϕ}_{P}} = 2 log {d}_{P} - log {ϕ}_{P} \qquad [ Equation 32 ]$$

When the diameter of particles d_{P} increases, the deterioration of Λ in the z-axis direction of −2 log d_{P} is offset by a change in log K_{V} of 2 log d_{P}. The reason will be described. Since the flat plate model has a 45° gradient on a trajectory like traversing a slope, when transforming the constant log p_{η}, it increases the effectiveness of log Π by 2 log d_{P}, which is the origin shift of log K_{V} , in the positive direction

Conversely, even though the diameter of particles is reduced and the 2log d_{P} is increased in the z-axis direction, since the origin of the log p_{η} is pulled by 2log d_{P} in the negative direction, the log Π is decreased and is eventually offset. This illustration shows the effect of adjusting the trajectory like traversing a slope to have a gradient of 45°. Since it climbs the flat plate with the trajectory like traversing a slope along the log Π axis, and the flat plate has a good gradient of 45°, in an ideal diameter of particles model, even though the horizontal component log K_{V} shifts, the shift will be equal to the change in the z-axis log Λ.

The landscape is formed only by n(u₀) of a first filler characteristic and is closed in a description up to Π. A may be introduced into the description which has been given so far. However, the pressure-driven PDC cannot avoid the pressure loss. Accordingly, although it is originally independent from the first filler characteristic, K_{V} of a second filler characteristic must be considered. Secondarily, a criterion of p_{η} is required, and it is believed that a description about the shift on the log Π axis is also necessary.

The idea of comparing K_{V} to H² is separation impedance E. H is the inverse of n, and n(u₀) is represented by nₘₐₓ. The height of the cliff cross section of the flat plate model is nₘₐₓ constant, but it can be extended by the ridge-profiling function f(u₀) to place the maximum point nₘₐₓ of uₒₚₜ on the log u₀ axis. The flat plate with Λ as the z-axis had a gradient of about 54.7° along the log L axis, but the ridge of uₒₚₜ is drawn by f(u₀). It is also useful to calculate E(u₀) when dealing with fully porous particulate fillers, but it is also meaningful to understand nₘₐₓ and K_{V} as they are, as shown in FIGS. 15 and 16. This is because when dealing with monolith columns and core-shell columns, nₘₐₓ and K_{V} are set as independent parameters, and a large amount of information can be captured. Based on this understanding, it may be used again when it is desirable to analyze using E(u₀) to deal with non-fully porous particulate fillers. In conclusion, full-logarithmic ΠtΛ-type three-dimensional graphs are useful for simultaneously visualizing n(u₀) and K_{V}.

High speed and high separation performance have been studied to understand UHPLC, but the contribution of the diameter of particles is offset in terms of separation performance and pressure characteristics. Ultimately, the Opt. method was used to devise a three-dimensional graph method that could extend the Knox-Saleem limit concept that there is an optimal diameter of particles for arbitrary pressure loss, to a variety of fillers.

In addition, it was found that there are two types of factors related to high sensitivity of UHPLC. One is the so-called semi-micro LC factor that reduces the cross-sectional area of the column, and the other is the contribution of the height-length product Σ newly introduced as a sensitivity index. Ideally, the former semi-micro LC does not affect the separation performance, but Σ has a reciprocity relation with N of the separation performance. The diameter of particles needs to be reduced to improve Σ having the smaller-the-better characteristic under the condition in which a constant N is secured. To visualize this relationship, a three-dimensional graph with N and diameter of particles as the input base plane and Σ as the z-axis was displayed. In addition, by replacing the z-axis on the same base plane with a pressure loss, it was possible to visualize the degree of increase in pressure linked to Σ. It was found that the miniaturization of fillers characterizing UHPLC and the application of the pressure corresponding thereto were indispensable to improve the sensitivity performance of UHPLC.

### Variable Not Requiring Pressure Unit

In the first half of Equation 26, tE is H²/Π and does not require units such as Kg for mass and Pa for pressure. In that case, ΔP, η, K_{V}, or p_{η} in the second half of Equation 26 are unnecessary. In addition, E(u₀) was introduced as a variable for mixing H and K_{V} while taking into account d_{P}, but E(u₀) is also unnecessary when K_{V} is taken as a secondary shifting variable for dealing with pressure, as described above. However, the usefulness of the idea of t_{E}=t₀/Λ remains to take advantage of the trajectory like traversing a slope. Here again, Π has units of time and length, and is uniquely found as a variable orthogonal to t₀ on the logarithmic axis of the base plane. In other words, the velocity-length product Π is a product of the LRC transformation associated with u₀, L, and t₀. Furthermore, Π can be considered as a driving index that can be used in common for PDC and SDC, instead of ΔP and p_{η}.

The Opt. method says that for every u₀, there exists each d_{P} at which u₀ becomes uₒₚₜ. This idea implies that ideally the u₀ axis has one-to-one correspondence with d_{P}. In other words, it means that the three degrees of freedom of the operational input variables (u₀, L, d_{P}) can be reduced to a base plane (uₒₚₜ, L) with two degrees of freedom. In the case of the base plane (uₒₚₜ, L), d_{P} is bound to uₒₚₜ, and when uₒₚₜ is specified, d_{P} is determined to be inversely proportional (see Equation 13).

The add-on speed-up method illustrated in FIG. 26 is slightly different from an ideal Opt. method in which d_{P} is bound to uₒₚₜ. The add-on speed-up method uses d_{P} and L fixed, and even though the linear velocity is increased, d_{P} is constant and is not interlocked with u₀. When the suboptimal linear velocity near uₒₚₜ is expressed as u_{sub},u_{sub} does not indicate a particular value but is set to a slightly higher value than uₒₚₜ. For this reason, in u_{sub}, N is slightly worse and lower than the ideal state.

The mechanism of ΔP is somewhat complex. In the add-on speed-up u_{sub} method, dp and L are constant. Therefore, K_{V} remains unchanged, and Π and ΔP increase slightly due to the contribution of u₀. On the other hand, when the speed-up is performed while increasing the linear velocity to u₀ by the Opt. method so that L is constant and same, it is an optimization method in which d_{P} is linked to u₀ or uₒₚₜ and is miniaturized. The K_{V} also deteriorates and decreases due to this miniaturization. In the case of the uₒₚₜ method, when uₒₚₜ is increased, ΔP is doubled and worsened by due to both Π and K_{V}. However, the advantage that N is slightly improved and increased due to the miniaturization of the filler is obtained.

### Comparison of t_{E} Between uₒₚₜ Method and u_{sub} Metho

The u_{sub} of the add-on speed-up method is practical, but is slightly deteriorated in terms of high-speed and high separation performance as compared to the ideal uₒₚₜ method. A method of quantitatively grasping this gap is devised. When t_{E} is introduced into Equation 26, Equation 33 is obtained.

$${t}_{E} ≡ \frac{{t}_{0}}{Λ} = \frac{{H}^{2}}{Π} \qquad [ Equation 33 ]$$

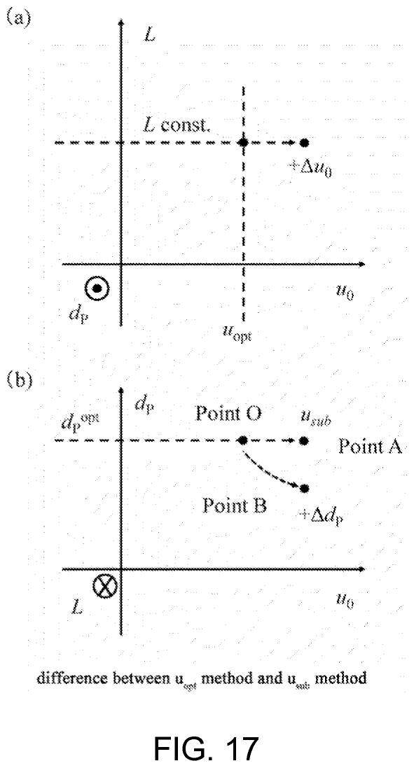

As a question, imagining a base plane (u₀, L), given an arbitrary starting point O(u⁰, L), the optimum linear velocity uₒₚₜ and the optimum diameter of particles d_{Popt} associated with uₒₚₜ are determined. In FIG. 17, the top plan view represents the base plane (u₀, L), and d_{P} of the z-axis extends forward from the surface of the paper. The bottom is a front view of the z-axis d_{P} at uoof the horizontal axis. In each case, L is constant. In the u_{sub} method, d_{P} is constant, and only u₀ is increased by +Δu₀ (point A). In the uₒₚₜmethod, u₀ is similarly increased by +Δu₀, and d_{P} also changes by +Δd with increasing u₀ (point B). In addition, +Δd_{P} descends in the negative direction. The way in which t_{E} changes with increasing u₀ will be compared between the two methods. As expressed by Equation 33, t_{E} has a characteristic of being able to be calculated without using to variables related to pressure.

The calculation procedure of the differential coefficient dt_{E}/du₀ is expressed by Equation 34. As a result, it is expected that there will be a difference between the u_{sub} method in which d_{P} is fixed to d_{Popt} and the uₒₚₜ method in which d_{P} is linked to u₀.

$${dt}_{E} = ( \frac{\partial {t}_{E}}{\partial H} ) dH + ( \frac{\partial {t}_{E}}{\partial Π} ) d Π = ( \frac{\partial {t}_{E}}{\partial H} ) \frac{\partial H}{{du}_{0}} {du}_{0} + ( \frac{\partial {t}_{E}}{\partial Π} ) \frac{d Π}{{du}_{0}} {du}_{0} \qquad [ Equation 34 ]$$

$$\frac{{dt}_{E}}{{du}_{0}} = ( \frac{2 H}{Π} ) \frac{dH}{{du}_{0}} + ( - \frac{1}{{Π}^{2}} ) L$$

The second term of Equation 34 does not differ between the u_{sub} method and the uₒₚₜ method. It can be seen that the difference occurs especially in the differential coefficient dH/du₀ of the first term.

First, in order to obtain dH/du₀ from Equation 3, partially differentiation with u₀ and d_{P} will be performed, resulting in the expression of Equation 35.

$$dH = ( \frac{\partial H}{\partial {u}_{0}} ) {du}_{0} + ( \frac{\partial H}{\partial {d}_{P}} ) {dd}_{P} \\ dH = ( - \frac{b}{{u}_{0}^{2}} + {cd}_{P}^{2} ) {du}_{0} + ( a + 2 {cd}_{P} {u}_{0} ) {dd}_{P} \qquad [ Equation 35 ]$$

In the case of the usub method, since d_{P} is constant, ddₚ is 0. D_{P} is a fixed value that maintains dPₒₚₜ obtained from Equation 13

$${d}_{P}^{opt} = \sqrt{\frac{b}{c}} \frac{1}{{u}_{opt}} \qquad [ Equation 36 ]$$

The dH/du₀ of the u_{sub} method is obtained by inputting dd_{P}= and Equation 36 into Equation 35 (Equation 37).

$$\frac{dH}{{du}_{0}} = - \frac{b}{{u}_{0}^{2}} + c \frac{b}{c} \frac{1}{{u}_{opt}^{2}} = b ( \frac{1}{{u}_{opt}^{2}} - \frac{1}{{u}_{0}^{2}} ) \qquad [ Equation 37 ]$$

As it can be seen from FIG. 17, Equation 37 is always positive because u₀ is slightly larger than uₒₚₜ. Therefore, in the case of the u_{sub} method, H slightly increases along u₀ and thus worsens.

On the other hand, in the case of the uₒₚₜ method, as shown in FIG. 17, d_{P} is a function of u₀ that decreases in conjunction with u₀ (Equation 38).

$${d}_{P} ( {u}_{0} ) = \sqrt{\frac{b}{c}} \frac{1}{{u}_{0}} \qquad [ Equation 38 ]$$

In addition, dd_{P} turns into Equation 39 through variable conversion.

$${dd}_{P} = ( \frac{\partial {d}_{P}}{\partial {u}_{0}} ) {du}_{0} = - \sqrt{\frac{b}{c}} \frac{1}{{u}_{0}^{2}} {du}_{0} \qquad [ Equation 39 ]$$

The dH/du₀ of the uₒₚₜ method is obtained by inputting Equation 38 and Equation 39 into Equation 35 (Equation 40).

$$\frac{dH}{{du}_{0}} = ( - \frac{b}{{u}_{0}^{2}} + c \frac{b}{c} \frac{1}{{u}_{0}^{2}} ) + ( a + 2 c \sqrt{\frac{b}{c}} \frac{1}{{u}_{0}} {u}_{0} ) ( - \sqrt{\frac{b}{c}} \frac{1}{{u}_{0}^{2}} ) = - ( a \sqrt{\frac{b}{c}} + 2 b ) \frac{1}{{u}_{0}^{2}} \\ \frac{dH}{{du}_{0}} = - \frac{a \sqrt{bc} + 2 bc}{c} \frac{1}{{u}_{0}^{2}} = - ( a + 2 \sqrt{bc} ) \sqrt{\frac{b}{c}} \frac{1}{{u}_{0}^{2}} = - ( a + 2 \sqrt{bc} ) {d}_{P} ( {u}_{0} ) \frac{1}{{u}_{0}} \qquad [ Equation 40 ]$$

The first term of Equation 40, derived from du₀, disappears. The second term, which is influenced by dd_{P}, remains, and dH/du₀ is always negative. That is, due to the contribution to of filler miniaturization, H decreases and improves. As can be seen from Equation 14, (a+2√ab)d_{P}(u₀) is a function of u₀ that is also called Hₘᵢₙ (u₀), and outputs the minimum value of H at a certain u₀. Hₘᵢₙ (u₀) is a unique concept of the uₒₚₜ method, conceived for the ideal condition in which d_{P} is linked to u₀, as expressed by Equation 38. Equation 31 is obtained from Equation 40.

$$\frac{dH}{{du}_{0}} = - {H}_{min} ( {u}_{0} ) \frac{1}{{u}_{0}} \qquad [ Equation 41 ]$$

For convenience, Hₘᵢₙ (u₀) can be defined as Equation 42.

Hₘᵢₙ(u₀≡(a+\sqrt{bc})d_{P}(u₀) [Equation 42]

However, it is desirable to define Hₘᵢₙ(u₀) such that it does not depend on the coefficients of equations such as Equation 3. Therefore, the height equivalent to a theoretical plate is first represented as a landscape of a two-variable function H(u₀, d_{P}). In addition, since uₒₚₜ, which gives the minimum value Hₘᵢₙ of H, is constrained as a function uₒₚₜ (dP) of d_{P}, uₒₚₜ (dP) in the base plane (u₀, d_{P}) depicts a curvilinear trajectory. Hₘᵢₙ (u₀) traces the minimum value on this trajectory. In other words, the original definition of Hₘᵢₙ (u₀) is the valley line connecting the lowest points along u₀ in a landscape.

### Summary of High-Speed High Separation Performance

FIG. 17 is a diagram illustrating a change in an operational input variable. The high-speed and high separation performance obtained therefrom can be measured at an impedance time t_{E} of Equation 33. Interestingly, no pressure-related variables are required.

The add-on speed-up method illustrated in FIG. 6 is a practical method, but it suffers a slight degradation in separation performance. As described above, the add-on speed-up method is also called u_{sub} method. On the other hand, the ideal method is called the uₒₚₜ method, and it features that the diameter of particles d_{P} of the filler is linked to the linear velocity u₀. However, in the laboratory, d_{P} cannot be freely changed by linking it to u₀, and the uₒₚₜ method is positioned as a theory used for result analysis and prediction. Needless to say, regarding to the optimization method for high speed and high separation performance, it is ideal to use the uₒₚₜ method. The suboptimal linear velocity u_{sub} method can literally shows almost the same performance.

As can be seen from the comparison between Equation 37 and Equation 40, the uₒₚₜ method improves high speed and high separation performance by allowing d_{P} to be changed. Regarding this, to understand the subtle differences, visualization based on the full-logarithmic ΠtΛ-type three-dimensional graph illustrated in FIG. 14 is necessary. Since the visualization function is provided, the logical development of comparing the t_{E} of the u_{sub} method and the t_{E} of the uₒₚₜ method has been made.

Although pressure is not mentioned in this description, as disclosed in Patent Literature 3, the process of miniaturizing d_{P} in the uₒₚₜ method completely offsets the improvement of H and the deterioration of K_{V} . Since the offsetting effect of such d_{P} is known, the analysis according to Equation 33 can be performed using Π as a driving index without wonying about the influence of pressure. Eventually, t_{E} could be calculated without considering pressure.

The impedance time is t_{E}, but there is a similar variable which is a plate time t_{P} (Equation 43). T_{P} is determined with a certain u₀ fixed. Fixing u₀ to uₒₚₜ is a naive idea. Since t_{P} is an analysis method assuming that u₀ is fixed, when viewed on the full-logarithmic ΠtΛ-type three-dimensional graph illustrated in FIG. 14, it is imaged such that the variable L changes only along the L axis. Since t_{P} is to per plate, t_{P} is invariant no matter how much N changes in proportion to L. Furthermore, it can be said that t_{P} has a good characteristic that Π and pressure need not be taken into account.

$${t}_{P} ≡ \frac{{t}_{0}}{N} = ( \frac{L}{N} ) ( \frac{{t}_{0}}{L} ) = \frac{H}{{u}_{0}} \qquad [ Equation 43 ]$$

On the other hand, as can be seen from the image illustrated in FIG. 14, the z-axis indicates Λ. This is because it has a proportional relationship of gradient 1 with respect to log Λ along log to axis or log Π axis. In other words, it is a 45° trajectory like traversing a down slope. t_{E} is defined in the base plane where both u₀ and L are variable. Therefore, even under the constraint conditions in which Π is constant or ΔP is constant, each logarithmic axis and limit can be drawn, so that high speed and high separation performance can be analyzed. It is also effective to link dPₒₚₜ of the uₒₚₜ method with the uₒₚₜ on the u₀ axis, that is, to reduce the degree of freedom of the operational input variable by one using a one-to-one correspondence relationship. Overall, the present invention can visualize to the user that the uₒₚₜ method considering up to d_{P} is ideal on this full-logarithmic ΠtΛ-type three-dimensional graph.

### Visualization of Four-Dimensional (4D) Graph

As one embodiment, addition of a particle diameter d_{P} to a basic three-dimensional graph having a linear velocity u₀, a column length L, and the theoretical number N of stages results in a four-dimensional graph, making visualization difficult. One challenge is how to visualize 4D graphs in an easily understandable way. For example, although FIGS. 7 and 8 are a type of four-dimensional graph, they are assumed to be four-dimensional graphs representing a 3-variable function N (u₀, L, d_{P}) having three input variables. Here, for preparation, one functional tool, i.e., the Logarithmically rotating coordinate (LRC) scope, is introduced. Taking into account the fact that the column length L is an input variable having no characteristics at all and serving only as a simple extensive variable, this tool is proposed. In other words, it is a concept that a three-dimensional graph related to N(u₀, d_{P}) is first expressed using the three variables having characteristics, and then the dimensions of the graph are increased by one dimension of L. This three-dimensional graph can be expressed using a true number axis, but it is more convenient to express it using a logarithmic axis for coordinate transformation, from the beginning

### LRC Scope

First, instead of N, a three-dimensional graph with a theoretical number of stages n(u₀, d_{P}) per unit length is displayed. Here, n on the z-axis is a characteristic function that is significantly affected by each of the input variables u₀ and d_{P} of the base plane. This three-dimensional graph is represented on a full-logarithmic axis. The reason why the z-axis is represented by n instead of N is that n is considered as a more fundamental characteristic function, as can be seen from the fact that N is two-dimensionally obtained by multiplying the extensive variable L by n.

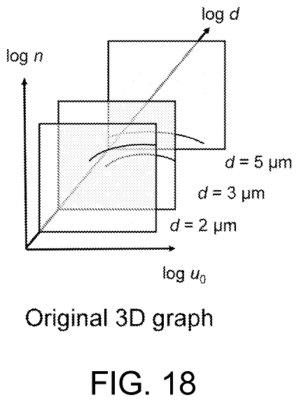

Here, n(u₀, d_{P}) can be expressed in a full-logarithmic graph as shown in FIG. 18. Here, n is the reciprocal of H, and if it fits the expression of Equation 3, it can be drawn as such. However, n(u₀, d_{P}) can be an arbitrary hilly terrain and does not necessarily follow the expression model of Equation 3. The flat plate illustrated in FIG. 18 is called an n-u₀ card because it looks exactly like a trump-card. Multiple n-u₀ cards stand successively, but it is expressed using a representative card in FIG. 18. In FIG. 18, the particle size is temporarily denoted as d for the deployment described later.

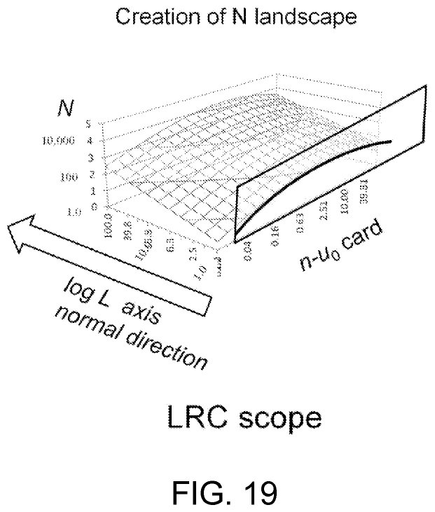

In the LRC scope, the user first specifies, for example, an n-u₀ card with a particle diameter of 2 μm, and extracts one card from the three-dimensional graph n (u₀, d_{P}). For the n-u₀ card, the LRC scoop is a function that adds the log L axis in a horizontal direction, perpendicularly to the card, thereby generating a new full-logarithmic three-dimensional graph. The display of the output is exactly as shown in FIG. 11. That is, the n-u₀ card is incorporated as a vertical plane element of the cliff cross-section to generate an N(u₀, L) full-logarithmic three-dimensional graph. The LRC scope can inflate the hilly terrain landscape in a three-dimensional space by extending the Log L axis in the normal direction to the card (see FIG. 19).

When the user specifies a particle size of 3 μm or 5 μm, the corresponding n-u₀ card is extracted, and N(u₀, L) three-dimensional graphs for respective particle sizes can be generated by the LRC scope function. The LRC scope is a function that adds the L-axis to make a two-variable function, in contrast that the n-u₀ card is a single-variable function n (u₀) having the z-axis n By expanding one input variable u₀ to the base plane (u₀, L) of a two-variable function, the z-axis is expanded from n to N. By adding the L axis to the n(u₀) card of the cliff cross-section, it is possible to inflate it to a hilly terrain landscape N(u₀, L) (see FIG. 19).

The LRC scoop function generates a hilly terrain N(u₀, L) from one n-u₀ card.

As can be seen from FIG. 18, the n-u₀ cards are arranged in a row along the d-axis. Therefore, when the LRC scopes is applied to each n-u₀ card, hilly terrains N(u₀, L) are generated in which the number of generated hilly terrains is equal to the number of cards. When each hilly terrain N(u₀, L) is drawn as a transparent three-dimensional graph, it can be conceptually superimposed on FIG. 18. However, in the case of a four-dimensional graph, since there are a considerable number of curves, it is difficult to distinguish particle diameters from each other. Therefore, something needs to be done for displaying.

By the way, since the base plane of the N(u₀, L) full-logarithmic three-dimensional graph of each particle diameter is (u₀, L) coordinates, there are also (1/√2) Log Π axis and (1 /√2) Log t₀ axis at positions rotated counterclockwise by 45° from the log u₀ axis and the log L axis that are orthogonal to each other, as shown in FIG. 10. These are the two major features of the LRC scope: dimensional extension; and number increment of bivariable. In reality, the increment of the variable n to N is regarded as the increment of three variables (u₀, L, n) to six variables (u₀, L, n, e, t₀, N). Up to six variables can be expressed by three-dimensional graphs, but the introduction of the variable d necessitated a method of displaying a 4-dimensional graph.

### Microstructure Parameter d

As shown in FIG. 18, the separation resolution is examined using the three-dimensional graph (u₀, d, n) as the origin. Several n-u₀ cards stand in a row toward the back, with the microstructure parameter d [m] as a parameter. For the purpose of handling not only total-porous particle-type columns but also monolithic columns and core-shell columns, the particle diameter d_{P} is extended, and d is introduced. For example, since the monolithic column is not a particle-type filler, the particle diameter d_{P} cannot be defined. The d is considered as an extended characteristic representative value so that the degree of microstructure, such as a monolithic column can also be expressed. Thus, d is a variable that is more abstract than d_{P}, and a smaller value of d represents a finer microstructure. Here, the subscript P means a particle. In the case of total-porous particles, d=d_{P}. For example, d is the representative diameter of the skeleton backbone of the monolithic column or the representative void size of the macropores. In the core-shell column, d can be selected as the particle size or thickness of the shell.

### Ridge Line of n

In FIG. 18, the cards are lined up back and forth as they were before the dominoes were knocked over. Since the theoretical number n of stages per unit length is the reciprocal of H, the convex graph in the n-u₀ card is equivalent to the van Deemter plot. Accordingly, a bird's-eye view of the three-dimensional graph (u₀, d, n) shows that the ridge line of the maximum values runs to connect the optimum flow velocity uₒₚₜ of each d.

To examine the characteristics of the ridge line, the partial differential coefficient ∂ₙ is defined by Equation 44.

$${\partial }_{n} ≡ {( \frac{\partial n}{\partial {u}_{0}} )}_{d} \qquad [ Equation 44 ]$$

Equation 44 is a three-dimensional graph illustrated in FIG. 18, and is a partial differential coefficient along u₀ of n that fixes the microstructure parameter d. The ridge line is a curve formed by connecting maximum points nm at which an is 0, that is, uₒₚₜ for each d. In general, it is easier to define ∂ₙ as Equation 45. Since H is the reciprocal of n, in the three-dimensional graph (u₀, d, H), the connection line of the minimum points Hₘᵢₙ at which H is 0 becomes a valley line.

$${\partial }_{H} ≡ {( \frac{\partial H}{\partial {u}_{0}} )}_{d} \qquad [ Equation 45 ]$$

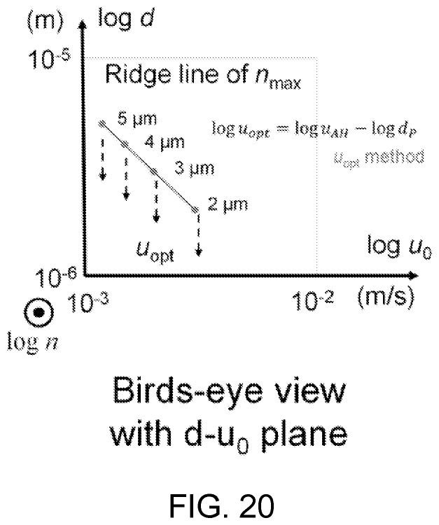

The base plane coordinates (u₀, d) of the ridge line and the bottom plane coordinates (u₀, d) of the valley line are the same when viewed from above. When H (u₀, d) can be expressed as Equation 3, the trajectory of the ridge line or valley line follows Equation 13, and the ordinate coordinates d will form an inversely proportional curve with respect to the abscissa u₀. This is true for true number notation, but when the d-u₀ graph is displayed on the logarithmic axis, the ridge line becomes a straight line (FIG. 20). In the present application, Equation 3 is only the positioning of the model equation, and even though the landscape n(u₀, d) is any hilly terrain, the ridge line can be obtained by simply introducing ∂ₙ.

FIG. 20 is a bird's-eye view of FIG. 18. In FIG. 18, each card has nₘₐₓ, but a curve that connects the maximum points nₘₐₓ for respective d's can be seen as a ridge line in the bird's-eye view. FIG. 20 shows that since uₒₚₜ follows the model expression of Equation 3, if it is displayed by a double logarithmic graph, the ridge line appears as a straight line.

### Interpretation of Scaling Scale Factor

One of the cards is extracted, and the LRC scope is applied thereto. Then, a three-dimensional graph of (u₀, L, N) appears. For example, it is a full-logarithmic graph of (u₀, L, N) for d=2 μm. As described above, a 45° counterclockwise logarithmic axis (Π, t₀) can be drawn on the same plane in the base plane (u₀, L). However, the log Π axis and the log t₀ axis are the products of multiplication by the scale factor 1/√2, and the z axis is log N (see FIG. 10).

For example, when log L is 1 at log u₀=1, the length of the diagonal corresponding to log Π is only √2 when measured on the graph. Therefore, the meaning of the scaling scale factor is that since the log Π of the length √2 is read as 2(u₀×L=Π; 10×10=100), it is written as (1/√2) log Π axis, which means that what was originally 2 is multiplied by 1/√2 and drawn to a length of √2.

### PPP Contour Diagram

Next, to make the scale factor of the log Π axis and the log to axis equal to 1, all the ticks of the logarithmic axes of the three-dimensional graph are shrunk to 1/√2 times. At this point, the 1√2 log u₀ axis, √2 log L axis, and √2 log N axis are obtained (FIG. 9). Here, since the trajectory like traversing a slope of the flat plate model is adjusted to an inclination of 45°, only the scale of the z-axis is further reduced to 1/√2 times, and 2log N=log Λ is taken as the z-axis (FIG. 15). This contour map, which is a full-logarithmic three-dimensional graph viewed from above, is called a PPP (picture between packings and pressure) contour map (FIG. 14). Since log Π is the sum of log p_{η} and log K_{V}, PPP implies an image that combines the filler and the pressure loss.

### Transparent PPP Contour Map

Going back to the origin, i.e., FIG. 18, it can be understood how the PPP contour map was obtained from a single card, using the LRC scope. Accordingly, there are respective PPP contour maps of 5 μm, 3 μm, 2 μm, . . . , and it is possible to overlay a few of them transparently by changing colors and line types. The overlay of the transparent contour maps is called a transparent PPP contour map. When (u₀, d, n) is inputted, the display function automatically increases the L axis and outputs (Π, t₀, Λ). Therefore, for example, a predetermined limit is imposed on the normalized pressure p_{η}, the ridge line uₒₚₜ is viewed from above, or there is a convenience effect in which the column permeability K_{V} changes according to d. Next, an embodiment in which a predeteimined limit is imposed on p_{η} will be described.

### High-Speed High Separation Resolution under Constant Pressure Loss

A scenario is considered in which the user wants to observe the behavior of the particle diameter from the viewpoint of high-speed high separation resolution under a constant pressure loss condition. For convenience, the microstructure parameters associated with viscosity is particularly set to d_{V}. In addition, microstructure parameters originating in N, n, or H in the z-axis direction are also referred to as d_{H}. The point of the present application is to treat d_{V} and d_{H} independently. In the case of the aforementioned monolithic column, the skeleton size corresponds to d_{H} and the macropore size corresponds to d_{V}. In the case of the core-shell column, the shell thickness corresponds to d_{H}, and the particle diameter corresponds to d_{P} or d_{V}. The present paragraph starts with the point in which the d axis of FIG. 18, which is the origin, is first read as the d_{V} axis.

When the user specifies a certain d_{V}, a landscape n(u₀, d_{V}) as shown in FIG. 18 is displayed. The hilly terrain is an arbitrary landscape that is not limited to Equation 3 with d_{P} being positive, in which d_{V} simply serves as a parameter specifying the filler. The user can activate the LRC scope for the n-u₀ card of the dv_{V} and output a PPP contour map shown in FIG. 14. There, a landscape N (u₀, L) of a certain d_{V} is formed. In the present embodiment, p_{η} is constant because the pressure loss is constant. Therefore, since d_{P} is replaced by dv by referring to Equation 25, p_{η} is constant, the variable affecting Π is only K_{V} proportional to the square of d_{V}. The viscosity-related microstructure parameter d_{V} plays a key role in extracting K_{V}.

Since the base plane (u₀, L) of the PPP contour map has 2 input variables, the degree of freedom is 2. When the optimum flow velocity uₒₚₜ is selected in advance in the PPP contour map of a certain d_{V}, the degree of freedom can be reduced from 2 to 1. Therefore, L becomes a variable that is dependent on Π. Since that the degree of freedom is 1 can be expressed as a certain variable, a one-variable scheme based on Π can be made. In reality, the one variable can be specified as either t₀ or L. However, in the present embodiment, it is convenient to make Π variable because p_{η} is fixed. The simple reason for choosing uₒₚₜ is that at each d_{V}, at least the maximum value nₘₐₓ is obtained for any L, as long as uₒₚₜ is selected. In other words, the advantage of broadly selecting u₀ rather than uₒₚₜ for a simple argument is that when the upper limit is applied to p_{η} on the Π axis, another suitable uₒₚₜ can be selected in the base plane (u₀, L) region in which uₒₚₜ cannot be selected. However, in the case of aiming for high speed, although the user wants to select a flow velocity u₀ higher than uₒₚₜ of a certain d_{V}, there are certainly a filler whose optimum flow velocity uₒₚₜ is the flow velocity u₀, and its nₘₐₓ. This logic is similar to the uₒₚₜ approach in which when different particle sizes are allowed, the optimal particle size and the optimum uₒₚₜ under pressure constraints can be obtained. Conversely, in the case of aiming for high separation resolution, u₀ that is slower than uₒₚₜ of a certain d_{V} is selected to extend L. However, the same insight can be considered because there are certainly a large filler d_{V} whose u₀ is uₒₚₜ and its nₘₐₓ. Roughly speaking, the logic is that for each flow velocity u₀, there is certainly a filler d_{V} whose optimum flow velocity uₒₚₜ is the flow velocity u₀. After that, the idea is to adjust the degree of freedom of 1 to Π or L.

### Total Porous Particles

Let's take the case where the filler such as silica gel is total porous particles. According to Equation 13, log uₒₚₜ is log u_{AH}-log d_{P}. u_{AH} is √(b/c), which is called Antia & Horvath's velocity coefficient named after the name of the discoverer. Since u_{AH}[m²/s] is a constant, log uₒₚₜ is scaled on the log u₀ axis as a function of the particle diameter d_{P} (Equation 46). By the way, u_{AH} is the same constant as Uₘᵢₙ described in Patent Document 3. In addition, the dimensionless coefficient a+2√(bc) of Equation 14 is called the Antia & Horvath's height coefficient h_{AH}, which is the same constant as hₘᵢₙ as described in Patent Document 3.

$$log {u}_{opt} = log \sqrt{\frac{b}{c}} - log {d}_{P} = log {u}_{AH} - log {d}_{P} \qquad [ Equation 46 ]$$

On a transparently superimposed PPP contour map, when the variable d_{P} is varied, K_{V} is a function of d_{P} and affects log Π. In the present embodiment, since log p_{η} is a constant, d_{P} uniquely determines log Π via log K_{V}. Equation 47 is obtained from Equation 25.

logΠ=logp_{η}+logK_{V}==logp_{η}+2logd_{P}−logϕ_{P} [Equation 47]

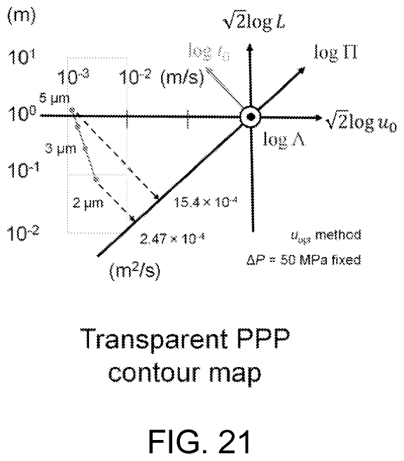

Similarly, d_{P} also affects uₒₚₜ on the basis of log u_{AH}, which is a constant. uₒₚₜ which is a function of d_{P} uniquely determines the coordinate on the log u₀ axis. Therefore, the parameter d_{P} is not visible on the transparent PPP contour map, but the trajectory thereof appears in a bird's-eye view (FIG. 21). In other words, when d_{P} is specified, K_{V} and uₒₚₜ are determined, and one point on the base plane defined by (u₀, Π) is uniquely obtained. This point rides on the surface of a hilly terrain within each PPP contour map, which also uniquely obtains t₀ for high speed and Λ for high separation resolution

FIG. 21 shows a full-logarithmic three-dimensional graph at each d_{P} of 2 μm, 3 μm, 4 μm, 5 μm, . . . This is the so-called transparent PPP contour map. First of all, when looking at uₒₚₜ for each d_{P}, it is found that the uₒₚₜ of 5 μm is the smallest. This is also shown in FIG. 20 where the uₒₚₜ decreases with the particle size d_{P} from the Antia & Horvath's velocity according to Equation 46. On the other hand, Equation 47 reflects projection values on the log Π axis shown in FIG. 21. Π is 15.4×10⁻⁴ m²/s for 5 μm and 2.47×10⁴ m²/s for 2 μm due to a large K_{V}. Thus, it is found that the larger particle size d_{P} effectively expands the movable region of Π Since uₒₚₜ and K_{V} are detemined by d_{P}, the coordinates of u₀ and Π can be obtained. As a result, the coordinate point of L is calculated. Comparatively, Π and L are larger at 5 μm, and u₀ and t₀ are larger at 2 μm. 2 μm is suitable for high-speed analysis, while 5 μm is suitable for high resolution analysis. To extend the L, it is found that 5 μm is effectively using Π.

That is, when p_{η} is specified, the high-speed high separation resolution trajectory (t₀, Λ) appears accordingly, and the various values uₒₚₜ, L, and Π can also be read. However, even though d_{P} is the cause and generates each point on the trajectory, d_{P} cannot be directly expressed in coordinates because it serves as a parameter.

For total-porous particles, d=d_{P}, and K_{V} and nₘₐₓ are offset. K_{V} is proportional to the square of d, and nₘₐₓ is inversely proportional to d_{P}. When this equation is applied to a transparent superimposed PPP contour map, the effect of finely refining d_{P} disappears. The scale factor √2, which is a symbolic scale factor in the LRC scope, and the adjustment of the z-axis to Λ on the basis of the gradient of the trajectory like traversing a slope influence this mechanism. The results are summarized in Tables 3 to 5.

The impedance time tE of Equation 26 is constant. t_{E} is the ratio of hold-up time t0 and Λ, and the reason of t_{E} being constant is that the trajectory like traversing a slope along the time axis has an inclination of 45° in a flat plate model. It is ingenious to assume that the flat model is the best ideal state. This ingenuity is assumed to be equivalent to the uₒₚₜ method. Therefore, the separation impedance E(u₀) with respect to the Knox & Saleem limit based on the uₒₚₜ method is a good indicator (Equation 26). The particle size d_{P} of total-porous particles influences K_{V} and influences nₘₐₓ or H(u₀) via uₒₚₜ. As shown Equation 26, the PPP depiction shows that the action is a performance index expressing that the numerator and the denominator of a fraction are canceled by K_{V} and the square of H.

The square of N in Equation must be Λ. However, a similar statement can be made for Σ, which is a sensitivity performance index so that the trajectory like traversing a slope can be adjusted to an inclination of 45° by squaring. Originally, N is derived from nL, and Σ is derived from HL. When the z-axis in FIG. 18 is replaced by the reciprocal of H in place of n, a similar logical development can be made, and Ξ, which is the aforementioned square of Σ, can serve as a useful sensitivity performance index like Λ. Ξ_{T} is a unit conversion system.

TABLE 3
List of result of transparent PPP contour map 1

| d_{P} | uₒₚₜ | K_{V} | Hₘᵢₙ | [symbol] |
|---|---|---|---|---|
| (×10⁻⁶ m) | (×10⁻³ m/s) | (×10¹⁵ m²) | (×10⁻⁶ m) | (×10⁻³ m²/s) |
| 2 | 3.00 | 2.67 | 6.24 | 0.247 |
| 3 | 2.00 | 6.00 | 9.36 | 0.556 |
| 4 | 1.50 | 10.7 | 12.5 | 0.988 |
| 5 | 1.20 | 16.7 | 15.6 | 1.54 |

[symbol]

indicates data missing or illegible when filed

TABLE 4
List of result of transparent PPP contour map 2

| d_{P} (×10⁻⁶ m) | L (×10 [symbol] m) | [symbol] (s) | N (×10³) | Λ (×10⁹) |
|---|---|---|---|---|
| 2 | 82.2 | 27.4 | 13.2 | 0.173 |
| 3 | 277 | 139 | 29.6 | 0.878 |
| 4 | 658 | 438 | 52.7 | 2.77 |
| 5 | 1,280 | 1,070 | 82.3 | 6.77 |

[symbol]

indicates data missing or illegible when filed

TABLE 5
List of result of transparent PPP contour map 3

| d_{P} | [symbol] _{E} | [symbol] _{P} | E | ΔP |
|---|---|---|---|---|
| (×10⁻⁶ m) | (×10⁻⁶ s) | (×10 [symbol] s) | (×10³ m) | (×10⁶ Pa) |
| 2 | 0.158 | 2.08 | 14.6 | 50 |
| 3 | 0.158 | 4.68 | 14.6 | 50 |
| 4 | 0.158 | 8.31 | 14.6 | 50 |
| 5 | 0.158 | 1.30 | 14.6 | 50 |

[symbol]

indicates data missing or illegible when filed

### Limiting Conditions of p_{η} in Ideal uₒₚₜ Method

Again, using the microstructure parameters d_{H} and d_{V}, the uₒₚₜ method for the optimum flow velocity limited by the normalized pressure p_{η} can be specified. Hₘᵢₙcan be expressed as Equation 48 using the Antia & Horvath's height coefficient hAh as described above, and the microstructure parameter d_{H} derived from H.

Hₘᵢₙ=h_{AH}d_{H} [Equation 48]

The uₒₚₜ that produces Hₘᵢₙ is represented by Equation 49. This is the real number representation of Equation 46, but the microstructure parameter is denoted by d_{H}.

$${u}_{opt} = \frac{{u}_{AH}}{{d}_{H}} \qquad [ Equation 49 ]$$

In fact, although being unrelated to the uₒₚₜ method, Equation 50 of K_{V}, which is related to Equation 47, will be prepared. To distinguish from d_{H}, the microstructure parameter for viscosity is set to d_{V} as described above.

$${K}_{V} = \frac{{d}_{V}^{2}}{{ϕ}_{P}} \qquad [ Equation 50 ]$$

Using these, the hold-up time to in which d_{H} and d_{V} are mixed can be derived (Equation n51).

$${t}_{0} = \frac{L}{{u}_{o p t}} = \frac{Π}{{u}_{opt}^{2}} = {p}_{η} {{K}_{V} ( \frac{{d}_{H}}{{u}_{AH}} )}^{2} = \frac{{p}_{η} {d}_{V}^{2}}{{ϕ}_{P}} \frac{{d}_{H}^{2}}{{u}_{AH}^{2}} \qquad [ Equation 51 ]$$

Similarly, N can be calculated (Equation 52).

$$N = \frac{L}{{H}_{min}} = \frac{Π}{{u}_{opt}} \frac{1}{{h}_{AH} {d}_{H}} = {p}_{η} {K}_{V} \frac{{d}_{H}}{{u}_{AH}} \frac{1}{{h}_{AH} {d}_{H}} = \frac{{p}_{η} {d}_{V}^{2}}{{ϕ}_{P}} \frac{1}{{u}_{AH} {h}_{AH}} \qquad [ Equation 52 ]$$

Accordingly, the impedance time t_{E} of Equation 26 can be obtained (Equation 53).

$${t}_{E} = \frac{{t}_{0}}{Λ} = \frac{{t}_{0}}{{N}^{2}} = ( \frac{{p}_{η} {d}_{V}^{2} {d}_{H}^{2}}{{ϕ}_{P} {u}_{AH}^{2}} ) {( \frac{{ϕ}_{P} {u}_{AH} {h}_{AH}}{{p}_{η} {d}_{V}^{2}} )}^{2} = \frac{{ϕ}_{P} {h}_{AH}^{2}}{{p}_{η}} \frac{{d}_{H}^{2}}{{d}_{V}^{2}} \qquad [ Equation 53 ]$$

Here, when each of d_{H} and d_{V} is equal to the particle diameter d_{P}, the left-hand side becomes a constant because d_{P} is offset. Therefore, t_{E} of total-porous particles does not depend on d_{P}, and t_{E} is constant as in Table 5. In addition, since d_{H} and d_{V} can be independently designed for the monolith column and the core-shell column, Equation 53 describes that when the viscosity-related d_{V} is increased relative to the d_{H} derived from H, t_{E} can be reduced, which contributes to high-speed high separation resolution.

Furthermore, when the u0 of E(u₀) that appears at tE of Equation 26, it becomes Eₒₚₜ of Equation 54.

$${E}_{opt} ≡ E ( {u}_{opt} ) = \frac{{H}_{min}^{2}}{{K}_{V}} = {ϕ}_{P} {h}_{AH}^{2} \frac{{d}_{H}^{2}}{{d}_{V}^{2}} \qquad [ Equation 54 ]$$

When looking at Equations 53 and 54, it is considered that tE is given the

dimension of time by dividing the dimensionless Eₒₚₜ by p_{η} [s⁻¹]. The advantage of monolithic and core-shell columns is that d_{V} can be set to be larger than d_{H} due to flowability, since a smaller Eₒₚₜ is desirable.

Similarly, in Table 5, d_{H} and d_{V} are offset due to the fact that they are each equal to the particle diameter d_{P}, which describes why E in Equation 54 is E constant.

### Use of Flat Plate Model and Understanding of Deviation

As seen in FIG. 11, the landscape N has uₒₚₜ as a ridge line and slopes from left to right. The flat plate is an ideal plane with the uₒₚₜ ridge line is extended left and right along the u₀ axis, while eliminating this left-right slant, as described above. When an arbitrary L coordinate is determined, it is a model that makes the N produced by uₒₚₜ equal to N at any u₀. In reality, since u₀ is not uₒₚₜ, N should be attenuated by the slope, but it is assumed that there is no such attenuation as an approximation. The z-axis height of the landscape is at most N at each L coordinate, and the flat model represents the upper limit of N. The flat plate model always replaces the value of the landscape N(u₀, L) with the height of the z-axis of N(uₒₚₜ, L) by simplification, and thus the value is constant. It is useful to understand the deviation between the flat model N(uₒₚₜ, L) and the actual landscape N(u₀, L). The β ratio can be defined as β(u₀) as in Equation 55, and it is possible to determine the actual degree of attenuation from the nₘₐₓ of the flat plate model.

$$β ( {u}_{0} ) ≡ \frac{{H}_{min}}{H ( {u}_{0} )} = \frac{n ( {u}_{0} )}{{n}_{max}} = \frac{N ( {u}_{0} , L )}{N ( {u}_{opt} , L )} \qquad [ Equation 55 ]$$

Since Hₘᵢₙis a minimum value, β(u₀) is a variable in a range of from 0 to 1, which is the deviation ratio between the actual landscape and the flat plate model. Slope B and Slope C in FIG. 11 show the degree of attenuation at the left side and the degree of attenuation at the right side, respectively with respect to the ridge line uₒₚₜ. The unattenuated N is the ridge line, meaning that the flat plate model does not increase its z-axis value to the extent of exceeding the ridge line.

Eₒₚₜ in Equation 54 can be extended to Equation 56 by using the β ratio.

$$E ( {u}_{0} ) = \frac{{\{ H ( {u}_{0} ) \}}^{2}}{{K}_{V}} = \frac{1}{{K}_{V}} {\{ \frac{{H}_{min}}{β ( {u}_{0} )} \}}^{2} = \frac{{E}_{opt}}{{\{ β ( {u}_{0} ) \}}^{2}} \qquad [ Equation 56 ]$$

Accordingly, t_{E} can be expressed as Equation 57.

$${t}_{E} ( {u}_{0} ) = \frac{E ( {u}_{0} )}{{p}_{η}} = \frac{{E}_{opt}}{{p}_{η} {\{ β ( {u}_{0} ) \}}^{2}} = \frac{{H}_{min}^{2}}{{p}_{η} {K}_{V} {\{ β ( {u}_{0} ) \}}^{2}} = \frac{{H}_{min}^{2}}{Π {\{ β ( {u}_{0} ) \}}^{2}}$$

Therefore, when the normalized pressure p_{η} is fixed, t_{E} depends on u₀. The dependence depends on the β ratio, which is the degree of attenuation of Slope B or Slope C. In addition, Eₒₚₜ is a constant for total-porous particles but varies depending on the ratio of d_{H} to d_{V} in the case of monolithic and core-shell columns. The operation in which Π can be changed by K_{V}, i.e., d_{V}, with p_{η} fixed. Note that d_{V} is introduced to explain the analogy with d_{H} and d_{P}, but if only Kv is known, it is not necessary to break particles down to d_{V}.

A normalized velocity, vₒₚₜ, is introduced to identify Slopes B and C (Equation 58). vₒₚₜ is a simple dimensionless ratio representing any linear velocity u₀, while regarding uₒₚₜ as the reference line velocity.

u₀=vₒₚₜuₒₚₜ [Equation 58]

Thus, for the base plane coordinates where vₒₚₜ is greater than 1, the landscape is in a slope C region, which is suitable for high speed. Similarly, for normalized velocities where vₒₚₜ is less than 1, the base plane coordinate point is on Slope B, which is suitable for high separation resolution. In a graph with z-axis n, the trajectory where vₒₚₜ is 1 corresponds to the ridge line on a topographic map.

### Finer Granulation of d_{P}

Suppose that the user simply considers a finer grain size of d_{P} in a range of from 4 μm to 2 μm under a flat plate model Λ where Λ is indicated on the z-axis. According to Equation 43, nₘₐₓ, which is the reciprocal of Hₘᵢₙ, is doubled. The cliff cross section (log L=0) of the flat plate model Λ is four times higher since it is the square of nₘₐₓ. Next, the optimal linear velocity uₒₚₜ is increased two times according to Equation 49. When the linear velocity Π is limited, L must be reduced to ½ times due to the effect of doubling uₒₚₜ. Finally, the column transmittance K_{V} decreases proportionally to the square of d according to Equation 50. When the normalized pressure p_{η} is limited, the movable range on the log Π axis is further reduced, and L must be reduced excessively to ½ times or less.

This logical development can be read from the contour map of FIG. 21. The case of d_{P} that is in a range of from 5 μm to 2 μm is common. The behavior in which uₒₚₜ moves in a positive direction along the √2 log u₀ axis, i.e., to the right side. In addition, in the projection to the log Π axis, with change in K_{V} , uₒₚₜ moves in a negative direction from 15.4×10⁻⁴ to 2.47×10⁻⁴ m²/s. Since the flow resistance of the column is increased due to finer granulation, the movable range of the column is reduced.

In FIG. 21, the log Π axis, the √2 log u₀ axis, and the √2 log L axis are on the same

base plane. The trajectory movement from 5 μm to 2 μm is projected on the √2 log L axis, and it is seen that L shrinks. In addition, the log to axis in FIG. 21 is orthogonal to the log Π axis, and is oriented in a diagonally upward to left. Accordingly, when being projected on the log to axis, the time is also reduced. In summary, the trajectory movement from 5 μm to 2 μm is characterized in to that with only an increase in uₒₚₜ, other elements such as L, Π, and t₀ are reduced. The characteristic producing the result in which the impedance time t_{E} is constant will be little more described below.

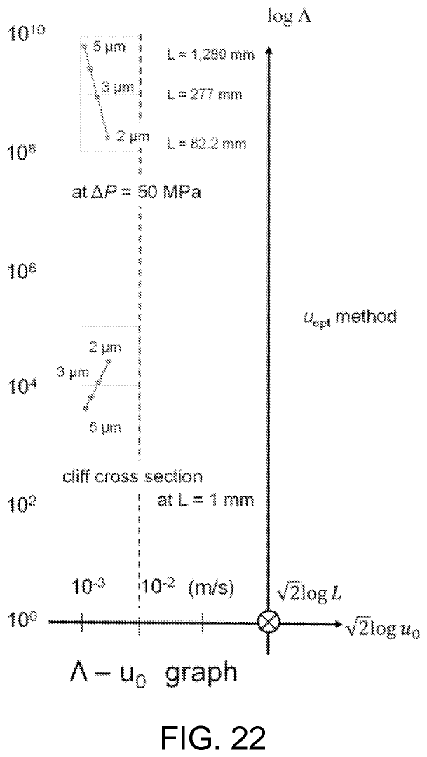

FIG. 22 illustrates changes in d_{P} using the z-axis as Λ. For example, when d_{P} is set to 5 μm, uₒₚₜ is uniquely determined. In FIG. 22, uₒₚₜ for each d_{P} at log L=0, i.e., L=1 mm, is shown in a lower part. The uₒₚₜ of 2 μm is larger than that of 5 μ and the horizontal line of each point corresponds to their respective cliff cross-sections. 2 μm is the largest among the heights Λ of the z-axis of the cliff cross-section. However, in the graph in an upper part of FIG. 22, 5 μm is the largest height Λ. Tables 3 to 5 show the reason. In other words, it can be said that the reason why the 5 μm is the largest height Λ in Table 4 is that the column length L is the longest to be 1,280 mm. With a constant pressure loss of ΔP=50 MPa, the column transmittance K_{V} of 5 μm is the highest and best, and as a result, the speed-length product Π indicating the range of motion may be widest. Since Π is the product of u₀ and L, 5 μm can produce the longest L. In addition, referring to Table 3, since the uₒₚₜ of 5 μm is the lowest, it is possible to obtain an even longer L for that amount.

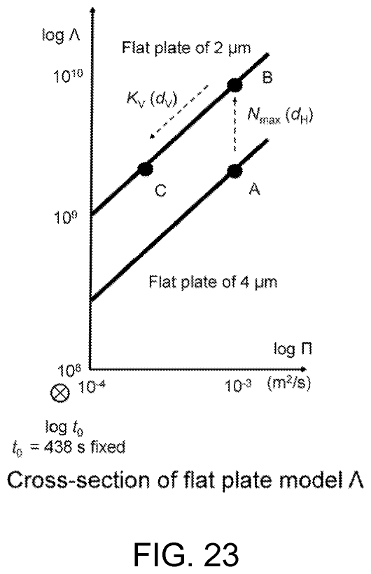

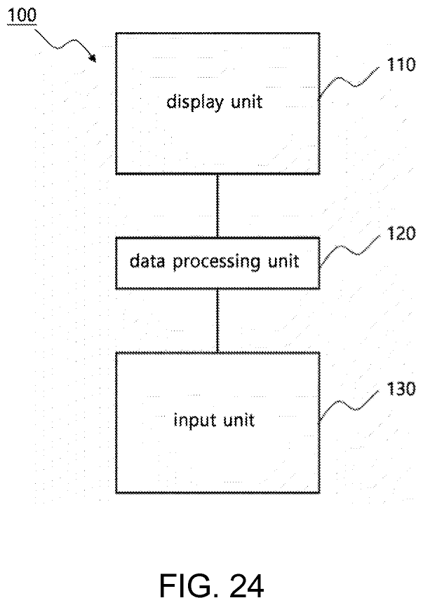

In FIG. 22, the axis of the inward direction is √2 log L. In the flat plate model Λ, the flat plate rises at a gradient of about 54.7°, as shown in FIG. 15. The gradient is constant as about 54.7° at nay d_{P}. The height of the cliff cross-section is larger than at a smaller d_{P}, and the height at 2 μm is larger in FIG. 22. Nonetheless, in the upper graph of FIG. 23, Λ at 5 μm is the largest because L is long, and the gradient is long, far, and uphill. FIG. 22 is considered a projection diagram of a flat plate projected from the front. In the lower cliff cross-section, in the case of the lowest 5 μm, it is necessary to climb the flat plate the longest distance, and in the upper graph, ΔP=50 MPa, it can reach the highest Λ. Incidentally, since ½ times of log Λ is log N, when the z-axis in FIG. 22 is scaled by half, the vertical axis is equal to log N.

In the same graph as in FIG. 22, the horizontal axis √2 log u₀ can be replaced with to log Π or log t₀. In this case, for any horizontal axis, the vertical axis Λ is a straight line presenting monotonic increases. This is evident from the fact that Π in Table 3 and to and Λ in Table 4 are larger at 5 μm.

### Comprehensive Example of Flat Plate Model

FIG. 13 can be viewed as in FIG. 15 by the LRC transformation and the transformation of N on the z-axis to Λ of the square thereof, as described above. Essentially, a topographic map of z-axis N or Λ exists in this coordinate space. The curved surface represented by the topographic map is a 2-variable function N(u₀, L), or Λ(Π, t0), with 2 variables chosen from a base plane coordinate system as input, and the scene is called a landscape. The landscape N or Λ features a single-value function in which the function needs to have only one point. That is, the z coordinate corresponding to any point on the base plane coordinates has only a single point. For this reason, at the time of displaying the function in a two-dimensional projection, it may be a graphical representation of a bird's-eye view viewed from above.

For simplicity, the understanding of Landscape Λ is aided by the introduction of the β-ratio in Equation 55, which is approximated by a flat plate model. The reason why the flat plate in FIG. 15 is inclined by about 54.7° is to set the gradient of the trajectory like traversing a slope along the log Π axis to 45° as described above. The flat plate is the landscape with the upper limit that can be reached for high separation performance, and on that flat plate, an increment of 1 on log Π results in an increase of 1 on log Λ. Similarly, for the log to must increase by 1 for an increase of log Λ on an ideal flat plate. These imply that Λ is proportional to each of Π and t₀.

First, the only characteristic parameter is the z-axis height of the cliff cross-section, i.e., log nₘₐₓ² because the flat plate model Λ has a constant gradient. Incidentally, in the flat plate model N, the height of the cliff cross-section is log nm (FIG. 13). However, the flat plate model Λ will be described here. nₘₐₓ is the reciprocal of Hₘᵢₙ, and is determined from d_{H}, which is a microstructure parameter, using h_{AH} according to Equation 48 of the uₒₚₜ method. The cliff cross-section of the flat plate is higher when d_{H} is finer. Since this graph is displayed in a logarithmic form, it is more convenient to think in terms of multiplication and division of a ratio. For example, when dri becomes ½ times, nₘₐₓ is doubled. Since log₁₀ 2 is 0.30, the height of the cliff, 2 log nₘₐₓ, is calculated by adding 0.60.

Next, the viewpoint is shifted from the z-axis to the log Π axis. Cases are considered in which p_{η} is limited to a certain value, like a case where there is an upper limit to the pressure drop. According to Equation 50, K_{V} is proportional to the square of d_{V}. As with the z-axis, when a new d_{V} is ½ times the original d_{V}, fluidity decreases such that K_{V} becomes ¼ times. Since the case is a case where p_{η} is constant, log Π decreases by log 2⁻², or by 0.60.

Here, assuming total-porous particles, the microstructure parameters of d_{H} and d_{V} are equal to the particle diameter d_{P}. Even though d_{P} is reduced by ½ times and the cliff height of the flat plate is increased by 0.60, since the upper limit of the log Π axis is reduced by 0.06, the effect of d_{P} is canceled out. This behavior can be seen in the cross-sectional view of log Λ-log Π with t₀ fixed (FIG. 23). In the projection, the slope of the flat plate is 1, and Λ and Π are proportional to each other.

As shown in FIG. 23, when the particle size is reduced from 4 μm to 2 μm, the cliff nₘₐₓ² is increased d_{H}, and is increased by 0.6 in logarithm. Here, the entire flat plate has an ascending slope from point A to point B. On the other hand, K_{V} decreases by ¼ times by d_{V} and decreases by 0.6 in logarithm. The flat plate has a descending slope from point B to point C in FIG. 23. Therefore, it is like a comparison in height Λ of the z coordinate between point A and point C. Since d_{H} and d_{V} can be designed independently for monolithic columns and core-shell columns, when improving du-induced separation performance while not deteriorating d_{V}-induced separation performance, it is possible to inhibit a decrease in the z-coordinate height log Λ of FIG. 23.

On the other hand, when looking at changes from point A to point B to pint C in a projection view of log Λ-log t₀, t₀ is constant, and only log Λ changes up and down. In other words, even though the plat plate is raised with d_{P} reduced to ½ times, since p_{η} is limited, it slides down with the trajectory like traversing a slope, along the log Π axis. The amount of log Λ by ascending and the amount of log Λ by descending are offset. In the flat plate model Λ, since the slope along the t₀ axis is 45°, the impedance time t_{E} that is obtained by dividing to by Λ is constant.

### Ohm's Law of Separation

As shown by Equation 59, it is well known that Dr. Knox compares this characteristic to Ohm's law. p_{η} corresponds to voltage, E corresponds to resistance, and t_{E}⁻¹ corresponds to current. Since the current t_{E}⁻¹ indicates high separation performance per hour, the reciprocal of the impedance time is referred to as a separation current I_{Λ}. A voltage p_{η} is to be applied to obtain a larger current I_{Λ}, but the separation impedance E resists. The dimension of Equation 59 is the reciprocal of time. Equation 59 is called Ohm's second law concerning separation. The normalized pressure p_{η} is exactly the potential difference, and is referred to as the separation potential difference.

$${p}_{η} ≡ E ( {u}_{0} ) {I}_{Λ} = E ( {u}_{opt} ) \frac{1}{{t}_{E}} = {E}_{opt} \frac{Λ}{{t}_{0}} = ( \frac{{H}_{min}^{2}}{{K}_{V}} ) \frac{Λ}{{t}_{0}} = ( \frac{{ϕ}_{P} {h}_{AH}^{2} {d}_{H}^{2}}{{d}_{V}^{2}} ) \frac{Λ}{{t}_{0}} \qquad [ Equation 59 ]$$

Here, since the equation is transformed as a flat plate model, u₀ can be substituted by Eₒₚₜ obtained using uₒₚₜ (Equation 54) or Hₘᵢₙ. In addition, because of the flat plate model, the gradient (log)/(log t₀) is 1 because it is a trajectory like traversing a slope, and Λ is proportional to t₀ as described above. In addition, since the product of p_{η} and K_{V} is Π, Λis also proportional to Π (Equation 26).

The flat plate model is an ideal model that provides optimum flow separation performance uₒₚₜ at any u₀, and the real landscape Λ attenuates for both slope B and slope C by maximizing the ridge line expressed by the β ratio. The separation impedance is defined as a function E(u₀) of u₀, but it is assumed that is extended to the function E(u₀) after the concept of the optimal Eₒₚₜ is established.

Ohm's law also leads to other expressions. When Equation 26 is denoted as Equation 60, the left side is multiplied by the speed-length product Π and the right side is multiplied by the square of H, so that the equation of the separation current I_{Λ} is obtained. Equation 60 is called Ohm's first law concealing separation. I_{Λ} commonly appears in Equation 59, Π corresponds to the voltage, and the square of H corresponds to the electrical resistance Ω. Therefore, the separation voltage Π corresponds to the electromotive force that is the source of u₀ and L, and the square of H can be referred to as the separation resistance Ω.

$$Π = {\{ H ( {u}_{0} ) \}}^{2} \frac{Λ}{{t}_{0}} = Ω ( {u}_{0} ) {I}_{Λ} \qquad [ Equation 60 ]$$

The unit of Equation 59 in the second law is [s⁻¹], whereas the unit of the first law Π is [m²s⁻¹]. The difference is due to the difference in whether the separation impedance E is defined to include the column permeability K_{V} or the separation impedance E is defined with only the theoretical stage equivalent height H like the separation resistance Ω. In order to quantify the pros and cons of finer column filler, Dr. Knox wanted to take into account not only the improvement in H, but also the column permeability K_{V}, which worsens flow resistance. The separation potential difference p_{η} is nothing but the pressure difference ΔP that takes the viscosity η into account. On the other hand, note that the separation voltage Π is a characteristic of being divided into p_{η} and K_{V} like the relationship of u₀ and L (Equation 25). It means that the effectively acquired separation voltage Π is affected by the K_{V} difference for the same p_{η}.

It can be said that regarding the Ohm's laws for Π and p_{η}, respectively, while the former first law (Equation 60) is a basic formula that does not cover the flow characteristics of the filler material, the latter second law (Equation 59) is a more practical and explicit expression with a strong awareness of pressure loss. The second law is based on the pressure difference ΔP, and the first law is based on the column length L. Here, L is a simple extensive variable. Furthermore, Equation 60 is obtained by multiplying each of both sides of Equation 50 by K_{V}. Therefore, it is assumed that the pressure is caused by K_{V}. Equation 60 is called the first law because it is unnecessary to consider the pressure when considering separation. In addition, the reason why the separation current I_{Λ} is defined as the ratio of Λ and t₀ is that Λ and t₀are roughly proportional to each other, and this property is significant.

Point C in FIG. 23 is illustrated as a cross-sectional view fixed at t0=438 s but can also be viewed as a projection of any t₀. In the case of a projection diagram, point C has a freedom degree of t₀ in the depth direction from the front. When FIG. 23 is viewed from above, a single trajectory with log Π being constant is depicted on the plane of the flat plate. In other words, since Π is constant, when t₀ is swept, u0 and L are determined for each t₀. Sometimes u₀ is near or far from uₒₚₜ The flat plate model is a good approximation when u₀ is near uₒₚₜ, but when u₀ is far from uₒₚₜ, the landscape is significantly attenuated. In fact, the point C fixed to t₀=438 s in FIG. 23 is behind the uₒₚₜ. The uₒₚₜ and to corresponding to the uₒₚₜ are both in front of point C. In reality, the point where u₀ should be pulled forward is positioned at point C because of the flat plate model in which there is no difference in Λ for any u₀. At point C, L is secured to some extent, but Λ slightly attenuates.

Under a condition in which Π is constant, the degree of freedom of the parameter t₀ allows point C in FIG. 23 to draw a trajectory. How close to should be t₀ the preceding tₒₚₜ, that is, how close u0 should be to the preceding uₒₚₜ, is an issue that needs to be closely studied. This issue is a useful item to be studied in the topographic map of the real landscape in order to maximize I_{Λ}, which the value of Λ per unit time.

In Patent Document 2, the time extension coefficient μ_{N/t} is introduced to quantify the approach to tₒₚₜ. Since there is a coefficient of 2 in the definition formula of μ_{N/t} , which means that the square of 2 is Λ, a new time elongation coefficient μ_{Λ/t} can also be defined as an index equal to μ_{N/t}. When t₀ is greater than tₒₚₜ, the effectiveness μ_{Λ/t} is less than 1, but Λ can be increased by multiplying by a constant gradient Π. Patent Document 3 shows that this increase is a monotonic increase for t₀, and there is an upper limit Nₛᵤₚ. In other words, the square of Nₛᵤₚ, is the upper limit Λₛᵤₚ, which is the critical value.

On the other hand, Π is constant, and I_{Λ} becomes maximum at tₒₚₜ along the time axis. This is because the separation current I_{Λ} is represented as Equation 61, and Hₘᵢₙ is obtained at uₒₚₜ, that is, at the time of tₒₚₜ, and it becomes the maximum value. A three-dimensional graph, such as landscape Λ is thought to be a representation method devised to visualize the Ohm's first law concerning separation.

$${I}_{Λ} ≡ \frac{Λ}{{t}_{0}} = \frac{Π}{{\{ H ( {u}_{0} ) \}}^{2}} = \frac{Π {\{ β ( {u}_{0} ) \}}^{2}}{{H}_{min}^{2}} \leq \frac{Π}{{H}_{min}^{2}} \qquad [ Equation 61 ]$$

### Symmetry of Separation Performance and Sensitivity Performance

When Equation 11 is applied to Equation 60, the sensitivity performance Σ can be expressed as Equation 62. As described above, Ξ is the square of Σ, and Λ is the square of N.

$$Π = {\{ H ( {u}_{0} ) \}}^{2} \frac{{N}^{2}}{{t}_{0}} = {\{ H ( {u}_{0} ) \}}^{2} {\frac{1}{{t}_{0}} [ \frac{Σ}{{\{ H ( {u}_{0} ) \}}^{2}} ]}^{2} = \frac{1}{{\{ H ( {u}_{0} ) \}}^{2}} \frac{{Σ}^{2}}{{t}_{0}} = \frac{1}{Ω ( {u}_{0} )} \frac{E}{{t}_{0}} = \frac{1}{Ω ( {u}_{0} )} {I}_{E} \qquad [ Equation 62 ]$$

Equation 62 is considered as the Ohm's first law concerning sensitivity. In this case, Π is the sensitivity voltage, the reciprocal of Ω is the sensitivity resistance, and I_{Ξ} is the sensitivity current. When compared with Equation 60, it is found that Λ and Ξ are symmetric, and N and Σ are symmetric. The only difference is that the resistance of the separation law is Ω, whereas the resistance of the sensitivity law is the reciprocal of Ω. Accordingly, the tactics obtained by the separation performance display method such as the flat plate model can also be applied to the sensitivity performance display method. However, it should be noted that while the separation performance uses ridge lines and maxima, the landscape Σ and the landscape Ξ use valley lines and minima because these have the smaller-the-better characteristic. Accordingly, in the case of sensitivity performance, it is not a scheme in which a strong sensitivity voltage VI is applied to obtain a large amount of sensitivity current I_{Ξ}. By dividing each of both sides of Equation 62 by K_{V}, the Ohm's second law p_{η} concealing sensitivity can be obtained. In this case, the constant of proportionality such as electrical resistance against I_{Ξ} of the sensitivity potential difference p_{η} is a value obtained by dividing the reciprocal of Ω by K_{V}. For convenience, I_{Ξ} may be referred to as the sigma current I_{Σ} and I_{Λ} may be referred to as the nucleotide current I_{N}, but the subscript notation of Ξ and Λ is preferable.

In terms of symmetry, the pressure application coefficient μ_{Σ/P} (CPA) and the time extension coefficient μ_{Σ/t} (CTE), which indicate the effectiveness described in Patent Document 2, can also be defined for sensitivity performance (Equation63 and Equation 64).

$${μ}_{Σ / P} ≡ 2 \frac{Π}{Σ} {( \frac{\partial Σ}{\partial Π} )}_{{t}_{0}} = {μ}_{Σ / Π} \qquad [ Equation 63 ]$$

$${μ}_{Σ / t} ≡ 2 \frac{{t}_{0}}{Σ} {( \frac{\partial Σ}{\partial {t}_{0}} )}_{Π} \qquad [ Equation 64 ]$$

This is because the coefficient 2 expressed as a formula has a characteristic in which the square of Σ is substantially proportional to Π and t₀, like the separation performance N based on the uₒₚₜ method (Equation 62). This is because the use of Λ and Ξ is highly convenient.

### General Overview of Field of HPLC

The separation performance can also be displayed by using the separation resolution R_{S} instead of N. The relationship between R_{S} and the theoretical number N of stages, including the retention time difference of two components, will be described using the formula of √N (Equation 65).

$${R}_{S} ≡ \frac{2 ( {t}_{2} - {t}_{1} )}{{W}_{2} + {W}_{1}} \approx \frac{{t}_{2} - {t}_{1}}{{W}_{2}} = \frac{\sqrt{N}}{4} \frac{( {t}_{2} - {t}_{1} )}{{t}^{2}} = \frac{\sqrt{N}}{4} \frac{{t}_{0} ( {k}_{2} - {k}_{1} )}{{t}_{0} ( {k}_{2} + 1 )} = \frac{\sqrt{N}}{4} \frac{( {k}_{2} - \frac{{k}_{2}}{α} )}{( {k}_{2} + 1 )} = \frac{1}{4} ( \frac{α - 1}{α} ) ( \frac{{k}_{2}}{{k}_{2} + 1} ) \sqrt{N} \qquad [ Equation 65 ]$$

Here, t₂, t₁, W₂, and W₁ are the retention times and total peak widths of peak 1 and peak 2, and W₁=W₂ is approximated by assuming that the adjacent base line widths are close. In addition, the formula N=16t₂²/W₂² defining the theoretical number of stages, and the relational formula tᵢ=t₀(kᵢ+1) of the retention time tᵢ and the retention coefficient kᵢ (where i=1, 2) are used. Here, t₀ is the hold-up time. In addition, the separation coefficient is defined as α=k₂/k₁, and the elution is made in order of peak 1 and peak 2. Starting from the definition expression of R_{S} of Equation 46, a well-known far-right expression is obtained. As can be seen from the expansion of the mathematical formula, since the separation resolution is considered to be isocratic elution, caution should be taken when using it for gradient elution. It is also necessary to bear in mind that a two-component system is considered, and it is more convenient to understand it as a one-component system, N, for the indication of separation performance as in the present application.

General HPLC separation methods starting from adsorption chromatography, including reversed-phase chromatography RPC, and ion-exchange chromatography IEC, including size-exclusion chromatography SEC, will be comprehensively described. Although the invention has been described basically with respect to the RPC, the invention is also applicable to the IEC. Therefore, the technical aspects of a high-speed amino acid analyzer AAA, which is, in principle, an IEC, are also covered in the present application.

Although the present invention is described from a fundamental theoretical point of view, it can of course be extended to applications. For example, although the embodiments of the present invention are based on isocratic elution, since isocratic elution is described, stepwise elution as well as gradient elution can be deduced. From the viewpoint of describing the migration behavior of solutes in a column, stepwise elution of two liquids can be described first by connecting the two instances of isocratic elution. Furthermore, multiple mobile phases can be used in succession. In the case of gradient elution, from the same perspective, infinitesimal time intervals may be integrated by perfoiming successive instances of stepwise elution.

In addition, the van't Hoff's equation for retention coefficient and temperature T [K] is used, and the Andrade's viscosity equation derived from the Arrhenius equation for the relationship between viscosity η and temperature is used. Since viscosity acts on p_{η}, temperature also affects Π of the present application. In addition, since the van Deemter's equation, which represents H, can be expanded to an expression containing a temperature-dependent diffusion coefficient Dm [m²/s], the temperature also affects the peak broadening. In Dₘ, m indicates diffusion in a mobile phase. Dr. Poppe defined Rudest velocity which is the result of division of the product of u₀ and d_{P} by Dₘ, but by rewriting the van Deemter's equation using the Rudest velocity, the temperature dependence of the van Deemter's equation can be expressed.

The IEC is based on equilibrium constants of a filler, solute, and mobile phase of a column, and there is a relational equation of the equilibrium constant and the retention coefficient. Furthermore, it is known that the dissociation properties of the amino acid molecules themselves vary depending on the component type according to the pH of the mobile phase. Cations and zwitterions of each amino acid are also produced on the basis of the equilibrium constants. Even through the zwitterions do not exhibit an ion-exchange phenomenon, the zwitterions may show a phenomenon of distribution to the filler. This distribution phenomenon also has a certain equilibrium constant.

### Other Matters

FIG. 18 is a schematic view illustrating a construction example of the liquid chromatographic data processing apparatus according to the described embodiment. The liquid chromatographic data processing apparatus 100 is, for example, a computer provided with a display unit 110, a data processing unit 120, and an input unit 130. The computer may be provided independently of a liquid chromatograph or may be connected to or built into the liquid chromatograph.

In addition, the liquid chromatographic data processing device as described above is not limited to being configured as a device including the display unit 110 that displays data generated through data processing, and the liquid chromatographic data processing device may be configured as device that outputs data generated by the data processing unit. Specifically, the liquid chromatograph may be an apparatus including, for example, a liquid delivery unit that transmits a mobile phase, a sample injection unit that injects a sample into a flow stream of the transmitted mobile phase, a column that separates the injected sample, a detection unit that detects the analytes separated, a controller that processes the detection results, and a controller that examines and sets operational and measurement conditions of the liquid delivery unit, the column, and the detection unit, and the like.

What is claimed is:

1. A liquid chromatographic data processing apparatus comprising a data processing unit that generates: display data displaying in accordance with a correspondence relationship of analytical condition data and analytical characteristic data of a chromatographic apparatus,
wherein the analytical condition data is of diameters of particles of a column filler, and
the analytical characteristic data are of a separation performance index and a sensitivity performance index.

2. The liquid chromatographic data processing apparatus of claim 1, wherein the display data are display data displaying values determined in accordance with graphs, tables, or given data.

3. The liquid chromatographic data processing apparatus of claim 1, wherein the data processing unit further generates display data displaying a diameter of particles at which the sensitivity performance index becomes optimal for a given separation performance index.

4. The liquid chromatographic data processing apparatus of claim 1, wherein the data processing unit further generates display data for displaying a correspondence relationship among a column length, a separation performance index, and a sensitivity performance index.

5. The liquid chromatographic data processing apparatus of claim 4, wherein the data processing unit further generates display data displaying the column length at which the sensitivity performance index or the separation performance index becomes optimal for a given separation performance index or a given sensitivity performance index.

6. The liquid chromatographic data processing apparatus of claim 1, wherein the data processing unit further generates display data for displaying a correspondence relationship among a flow rate of a mobile phase that is sent to a column, a high-speed performance index, and a pressure-related index.

7. The liquid chromatographic data processing apparatus of claim 6, wherein the data processing unit further generates display data in accordance with a correspondence relationship between the high-speed performance index and either the sensitivity performance index or the flow rate for the given pressure-related index.

8. A liquid chromatographic data processing apparatus comprising a data processing unit that generates display data for displaying a correspondence relationship between data concerning analytical conditions of a chromatographic apparatus and data concerning analytical characteristics,
wherein the data concerning the analytical conditions is of a particle size of a column filler, and
the data concerning the analytical characteristics is of a separation performance index.

9. A liquid chromatographic data processing apparatus comprising a data processing unit that generates display data for displaying a correspondence relationship between data concerning analytical conditions of a chromatographic apparatus and data concerning analytical characteristics,
wherein the data concerning the analytical conditions is of a particle size of a column filler, and
the data concerning the analytical characteristics is of a sensitivity performance index.
